(19) United States
(12) Patent Application Publication
(10) Pub. No.: US 2026/0280214 A1
(43) Pub. Date: Sep. 17, 2026

(54) AUTOMATIC CONTACT LOADER APPARATUS FOR LOADING A HANDHELD CRIMPER TOOL

(71) Applicant: Tri-Star Technologies, Inc., El Segundo, CA (US)

(72) Inventors: Alex Kerner, Pacific Palisades, CA (US); Anton Ushakov, Woodland Hills, CA (US); Katherine Kerner, Pacific Palisades, CA (US)

(21) Appl. No.: 19/568,574

(22) Filed: Mar. 16, 2026

Related U.S. Application Data
(60) Provisional application No. 63/772,371, filed on Mar. 14, 2025.

(51) Int. Cl. H01R 43/055; H01R 43/042

(52) U.S. Cl. CPC H01R 43/055; H01R 43/042

(57) ABSTRACT

An automatic contact loader apparatus may include a magazine receptacle, a contact magazine, a tool receptacle, and a staging zone camera directed toward a contact staging zone. The contact magazine may include a conveyor actuatable to sequentially conveyingly transport discrete electrical contacts to a contact discharge gate. The contact discharge gate may be placed in contact feeding communication with a contact inlet window of the magazine receptacle. A contact turntable may be disposed within the contact staging chamber to receive a discrete electrical contact from a contact input port. The contact turntable may be commandable to rotate to a first release orientation and a second release orientation. A dispense guide tube may be in electrical contact guiding communication between a contact release port of the contact staging chamber and a contact dispense port of the tool receptacle. The tool receptacle may receive a crimping portion of a handheld crimper tool.

### RELATED APPLICATIONS

This application claims the benefit of U.S. Provisional Application No. 63/772,371 filed Mar. 14, 2025, the content of which is incorporated by this reference in its entirety for all purposes as if fully set forth herein.

### TECHNICAL FIELD

The disclosure herein relates generally to automated crimping products, including those produced originally for the aerospace and defense industry.

### BACKGROUND

Historically, an operator typically must manually pick out an electrical contact, visually inspect it, orient it, and make sure it is correctly inserted into their crimp tool before taking their stripped wire and inserting that into the electrical contact and squeezing the crimp. In most cases, this takes up precious time and opens up the possibility of a bad crimp. Generally, the contacts can fall onto the harness board, or worse, into the aircraft and create FOD. These issues, among others, are addressed by implementations of the apparatus disclosed herein.

### SUMMARY

Certain deficiencies of the prior may be overcome by way of implementations of an automatic contact loader apparatus in accordance with the present disclosure. Particular implementations of the apparatus may be designed to be small and portable, facilitating pairing on the shop floor with existing handheld crimpers, such as a DMC tool. In certain implementations of the apparatus, all the operator may need to do is dump their electrical contacts into a contact magazine and insert the contact magazine into the magazine receptacle for the apparatus to automatically orient and correctly present the electrical contact in the operator's handheld crimper tool. This may, in some implementations of the apparatus, increase productivity by about 3×, help with inventory control, and help eliminate the risk of FOD. The apparatus may be designed to accommodate different contact magazines for different electrical contact sizes as well as various handheld crimper sizes.

### BRIEF DESCRIPTION OF THE DRAWINGS

Further advantages of the present invention may become apparent to those skilled in the art with the benefit of the following detailed description of the preferred implementations and upon reference to the accompanying drawings in which:

FIG. 1 is a perspective view of an example automatic contact loader apparatus;

FIG. 2 is a perspective view of an example handheld crimper tool;

FIG. 3 is a perspective view of an example automatic contact loader apparatus shown in receipt of a crimping portion of the handheld crimper tool of FIG. 2;

FIG. 4 is a further perspective view of the apparatus of FIG. 1;

FIG. 5 is a further perspective view of the apparatus of FIG. 1;

FIG. 6 is a further perspective view of the apparatus of FIG. 1;

FIG. 7 is a further perspective view of the apparatus of FIG. 1;

FIG. 8 is a first side view of the apparatus of FIG. 1;

FIG. 9 is a second side view of the apparatus of FIG. 1;

FIG. 10 is a front view of the apparatus of FIG. 1;

FIG. 11 is a rear view of the apparatus of FIG. 1;

FIG. 12 is a top view of the apparatus of FIG. 1;

FIG. 13 is a bottom view of the apparatus of FIG. 1;

FIG. 14 is a cross-sectional view taken along lines 14-14 in FIG. 10;

FIG. 15 is a side view similar to FIG. 8, but wherein the hidden lines are shown;

FIG. 16 is a cross-sectional view taken along lines 16-16 in FIG. 15, showing a contact turntable in a contact staging orientation and an electrical contact in a first staged orientation;

FIG. 17 is a cross-sectional view similar to FIG. 16, but wherein the contact turntable is shown in a first release orientation;

FIG. 18 is a cross-sectional view similar to FIG. 16, but wherein the electrical contact is shown in a second staged orientation;

FIG. 19 is a cross-sectional view similar to FIG. 17, but wherein the contact turntable is shown in a second release orientation;

FIG. 20 is a broken cross-sectional view of the apparatus of FIG. 1, showing an electrical contact leaving a contact staging chamber through a contact release port and a tool contact aperture of a handheld crimper tool in alignment with a contact dispense port;

FIG. 21 is a broken cross-sectional view similar to FIG. 20, but wherein the electrical contact is shown traveling through a dispense guide tube between the contact release port and the contact dispense port;

FIG. 22 is a broken cross-sectional view similar to FIG. 21, but wherein the electrical contact is shown having traveled through the contact dispense port and having been received by the tool contact aperture of the handheld crimper tool;

FIG. 23 is a process view of a display monitor, illustrating a plurality of example sequential displays shown during operation of an automatic contact loader apparatus;

FIG. 24 is a perspective view of an example contact turntable;

FIG. 25 is a further perspective view of the contact turntable of FIG. 24;

FIG. 26 is a top view of the contact turntable of FIG. 24;

FIG. 27 is a cross-sectional view taken along lines 27-27 in FIG. 26;

FIG. 28 is a perspective view of an example electrical contact;

FIG. 29 is a perspective view similar to FIG. 4, but wherein the apparatus is shown in a configuration with the contact magazine detached;

FIG. 30 is a further perspective view of the configuration of FIG. 29;

FIG. 31 is a rear view similar to FIG. 11, but wherein the contact magazine is removed;

FIG. 32 is a cross-sectional view taken along lines 32-32 in FIG. 31, showing a contact magazine in a precursor configuration prior to being placed in a first engagement position;

FIG. 33 is a cross-sectional view similar to FIG. 32, but wherein the contact magazine is shown in the first engagement position;

FIG. 34 is a cross-sectional view similar to FIG. 32, but wherein the contact magazine is shown in pivotable rotation about an example magazine retention boss, moving between the first engagement position and a second engagement position, and the rearward and forward bottom edges of the contact magazine traveling through example edge reliefs;

FIG. 35 is a cross-sectional view similar to FIG. 33, but wherein the contact magazine is shown in a second engagement position;

FIG. 36 is a perspective view of a configuration including an example contact magazine and an example conveyance actuation subsystem;

FIG. 37 is a further perspective view of the configuration of FIG. 36;

FIG. 38 is a side view of the configuration of FIG. 36;

FIG. 39 is a front view of the configuration of FIG. 36;

FIG. 40 is a cross-sectional view taken along lines 40-40 in FIG. 39, illustrating a conveyor actuator in actuating engagement with a conveyor and the conveyor in a conveyor upper position with respect to the magazine housing;

FIG. 41 is a cross-sectional view similar to FIG. 40, but wherein the conveyor is shown in a conveyor lower position with respect to the magazine housing;

FIG. 42 is a perspective view of an example contact magazine in a configuration with the magazine lid open;

FIG. 43 is a further perspective view of the configuration of FIG. 42;

FIG. 44 is a perspective view similar to FIG. 42, but wherein the contact magazine is shown in a configuration with the magazine lid closed;

FIG. 45 is a front view of the configuration of FIG. 44;

FIG. 46 is a cross-sectional view taken along lines 46-46 in FIG. 45;

FIG. 47 is a cross-sectional view taken along lines 47-47 in FIG. 45;

FIG. 48 is a further cross-sectional view taken along lines 47-47 in FIG. 45;

FIG. 49 is a first exploded view of the contact magazine of FIG. 42;

FIG. 50 is a second exploded view of the contact magazine of FIG. 42;

FIG. 51 is a perspective view of an example magazine housing;

FIG. 52 is a top view of the magazine housing of FIG. 51;

FIG. 53 is a further perspective view of the magazine housing of FIG. 51;

FIG. 54 is a bottom view of the magazine housing of FIG. 51;

FIG. 55 is a side view of the magazine housing of FIG. 51;

FIG. 56 is a cross-sectional view taken along lines 56-56 in FIG. 55;

FIG. 57 is a front view of the magazine housing of FIG. 51;

FIG. 58 is a cross-sectional view taken along lines 58-58 in FIG. 57;

FIG. 59 is a perspective view of an example conveyor;

FIG. 60 is a further perspective view of the conveyor of FIG. 59;

FIG. 61 is a rear view of the conveyor of FIG. 59;

FIG. 62 is a bottom view of the conveyor of FIG. 59;

FIG. 63 is a top view of the conveyor of FIG. 59;

FIG. 64 is a cross-sectional view taken along lines 64-64 in FIG. 61;

FIG. 65 is a perspective view of a configuration including an example conveyor, an example conveyance actuation subsystem, and an example contact staging subsystem;

FIG. 66 is a front view of the configuration of FIG. 65;

FIG. 67 is a cross-sectional view taken along lines 67-67 in FIG. 66, showing a variety of aspects including an example stepper motor, an example cam element, an example cam follower, an example carriage element, an example guide rail, and an example conveyance mount frame;

FIG. 68 is a magnified view of detail 68 in FIG. 65;

FIG. 69 is a perspective view of the stepper motor of FIG. 67;

FIG. 70 is a perspective view of the cam element of FIG. 67;

FIG. 71 is a further perspective view of the cam element of FIG. 67;

FIG. 72 is a perspective view of the cam follower of FIG. 67;

FIG. 73 is a further perspective view of the cam follower element of FIG. 67;

FIG. 74 is a front view of the cam follower element of FIG. 67;

FIG. 75 is a cross-sectional view taken along lines 75-75 in FIG. 74;

FIG. 76 is a perspective view of the carriage element of FIG. 67;

FIG. 77 is a further perspective view of the carriage element of FIG. 67;

FIG. 78 is a front view of the carriage element of FIG. 67;

FIG. 79 is a cross-sectional view taken along lines 79-79 in FIG. 78;

FIG. 80 is a perspective view of the guide rail of FIG. 67;

FIG. 81 is a front view of the guide rail of FIG. 67;

FIG. 82 is a cross-sectional view taken along lines 82-82 in FIG. 81;

FIG. 83 is a perspective view of the conveyance mount frame of FIG. 67;

FIG. 84 is a bottom view of the conveyance mount frame of FIG. 67;

FIG. 85 is a rear view of the conveyance mount frame of FIG. 67;

FIG. 86 is a further perspective view of the conveyance mount frame of FIG. 67;

FIG. 87 is a perspective view similar to FIG. 6, but wherein the front frame and the display subsystem are removed, showing a variety of aspects including an example middle frame, an example contact funnel, an example staging chamber housing, an example dispense guide tube, an example tool receptacle housing, an example turntable motor mounting plate, an example staging zone camera, an example turntable motor, an example tool proximity sensor, and an example computer element;

FIG. 88 is a perspective view of the middle frame of FIG. 87;

FIG. 89 is a further perspective view of the middle frame of FIG. 87;

FIG. 90 is a further perspective view of the middle frame of FIG. 87;

FIG. 91 is a further perspective view of the middle frame of FIG. 87;

FIG. 92 is a perspective view of the contact funnel of FIG. 87;

FIG. 93 is a further perspective view of the contact funnel of FIG. 87;

FIG. 94 is a perspective view of the staging chamber housing of FIG. 87;

FIG. 95 is a further perspective view of the staging chamber housing of FIG. 87;

FIG. 96 is a perspective view of the dispense guide tube of FIG. 87;

FIG. 97 is a side view of the dispense guide tube of FIG. 87;

FIG. 98 is a bottom view of the dispense guide tube of FIG. 87;

FIG. 99 is a cross-sectional view taken along lines 99-99 in FIG. 98;

FIG. 100 is a perspective view of the tool receptacle housing of FIG. 87;

FIG. 101 is a further perspective view of the tool receptacle housing of FIG. 87;

FIG. 102 is a front view of the tool receptacle housing of FIG. 87;

FIG. 103 is a side view of the tool receptacle housing of FIG. 87;

FIG. 104 is a perspective view of the turntable motor mounting plate of FIG. 87;

FIG. 105 is a top view of the turntable motor mounting plate of FIG. 87;

FIG. 106 is a cross-sectional view taken along lines 106-106 in FIG. 105;

FIG. 107 is a perspective view of the staging zone camera of FIG. 87;

FIG. 108 is a further perspective view of the staging zone camera of FIG. 87;

FIG. 109 is a perspective view of the example turntable motor of FIG. 87;

FIG. 110 is a perspective view of the tool proximity sensor of FIG. 87;

FIG. 111 is a perspective view of the computer element of FIG. 87;

FIG. 112 is a perspective view similar to FIG. 6, but wherein the display subsystem is in an exploded configuration showing a variety of aspects including an example display monitor, an example monitor frame, and an example monitor frame locker;

FIG. 113 is a further perspective view of the apparatus and display subsystem configuration of FIG. 112;

FIG. 114 is a perspective view similar to FIG. 113, but wherein the monitor frame locker is shown engaged with the monitor frame;

FIG. 115 is a broken cross-sectional view taken along lines 115-115 in FIG. 8;

FIG. 116 is a perspective view of the monitor frame locker of FIG. 112;

FIG. 117 is a top view of the monitor frame locker of FIG. 112;

FIG. 118 is a cross-sectional view taken along lines 118-118 in FIG. 117;

FIG. 119 is a cross-sectional view taken along lines 119-119 in FIG. 9, showing a variety of aspects including an example bottom frame, an example AC-DC converter module, an example on-off switch, an example connector element, and an example stepper motor driver;

FIG. 120 is a perspective view of the bottom frame of FIG. 119;

FIG. 121 is a bottom view of the bottom frame of FIG. 119;

FIG. 122 is a perspective view of the AC-DC converter module of FIG. 119;

FIG. 123 is a perspective view of the on-off switch of FIG. 119;

FIG. 124 is a perspective view of the stepper motor driver of FIG. 119;

FIG. 125 is a perspective view of a further implementation of an example conveyor wherein the stair widths incrementally decrease from the conveyor rearward end to the conveyor forward end;

FIG. 126 is a further perspective view of the conveyor of FIG. 125;

FIG. 127 is a front view of the conveyor of FIG. 125;

FIG. 128 is a top view of the conveyor of FIG. 125;

FIG. 129 is a perspective view of a further implementation of an example conveyor wherein the stair widths incrementally decrease from the conveyor rearward end to the conveyor forward end;

FIG. 130 is a further perspective view of the conveyor of FIG. 129;

FIG. 131 is a front view of the conveyor of FIG. 129;

FIG. 132 is a top view of the conveyor of FIG. 129;

FIG. 133 is a perspective view of a further implementation of an example magazine housing, the lateral inboard walls having a narrowing taper corresponding to the stair widths of the conveyor of FIG. 125;

FIG. 134 is a front view of the magazine housing of FIG. 133;

FIG. 135 is a top view of the magazine housing of FIG. 133;

FIG. 136 is a bottom view of the magazine housing of FIG. 133;

FIG. 137 is a perspective view of a further implementation of an example magazine housing, the lateral inboard walls having a narrowing taper corresponding to the stair widths of the conveyor of FIG. 129;

FIG. 138 is a front view of the magazine housing of FIG. 137;

FIG. 139 is a top view of the magazine housing of FIG. 137;

FIG. 140 is a bottom view of the magazine housing of FIG. 137;

FIG. 141 is an example schematic diagram; and

FIG. 142 is one example method of operation of an apparatus.

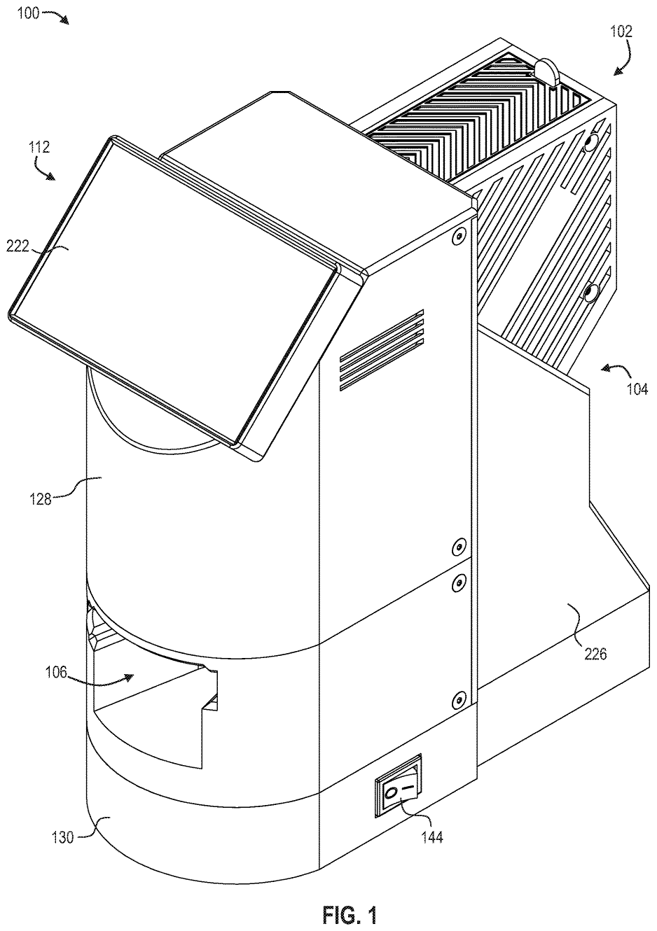

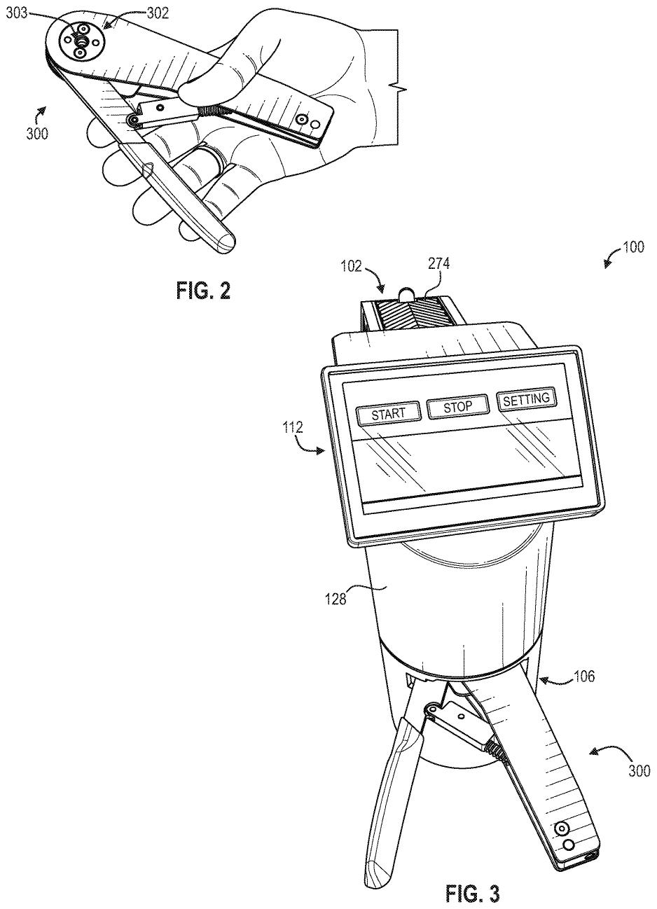

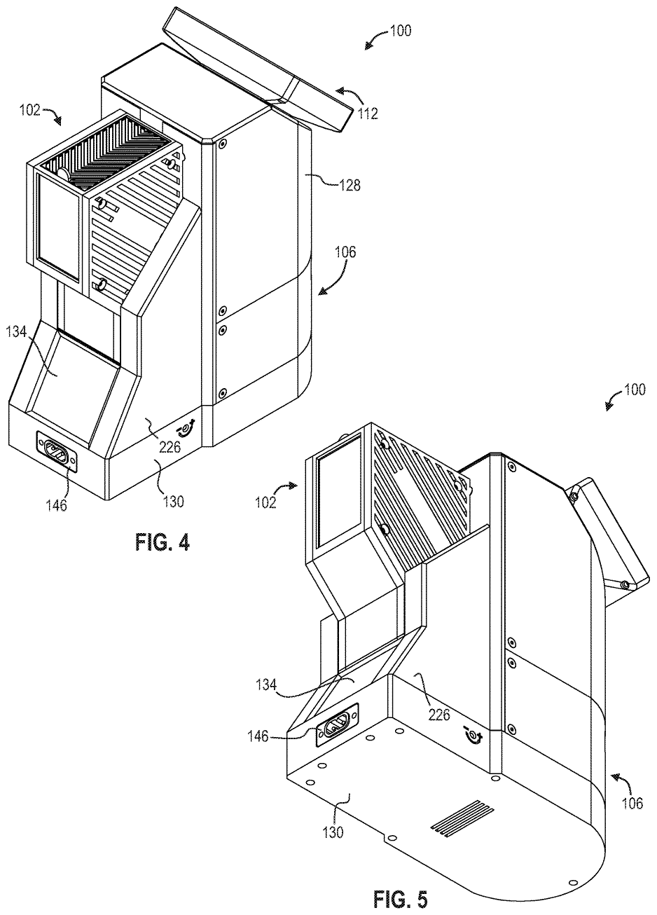

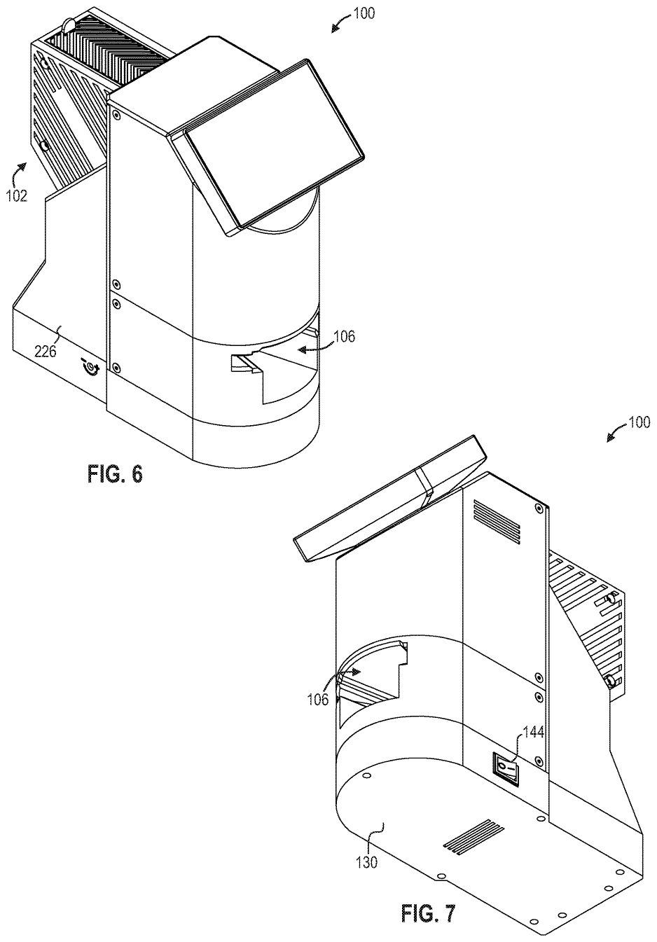

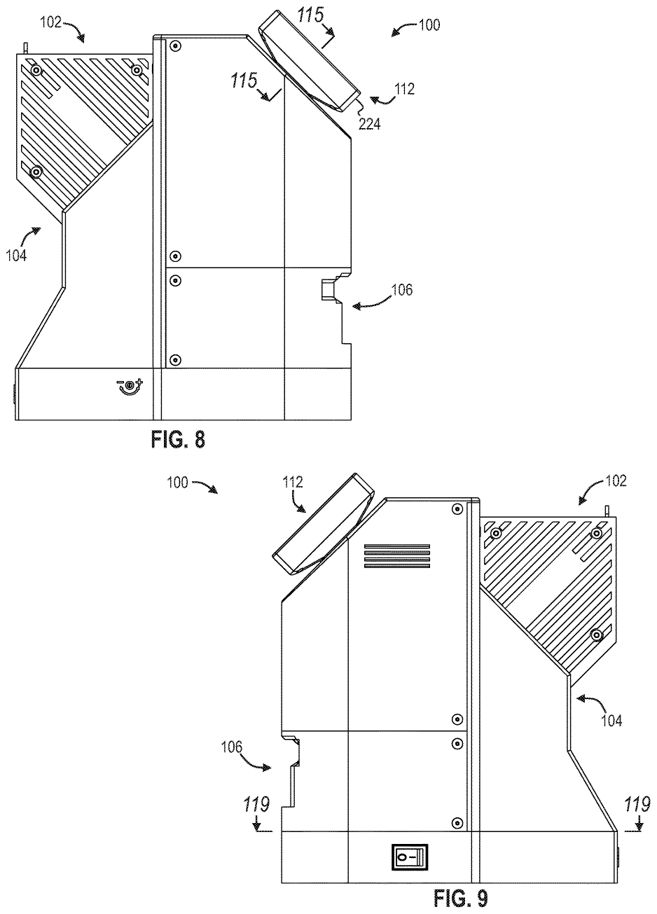

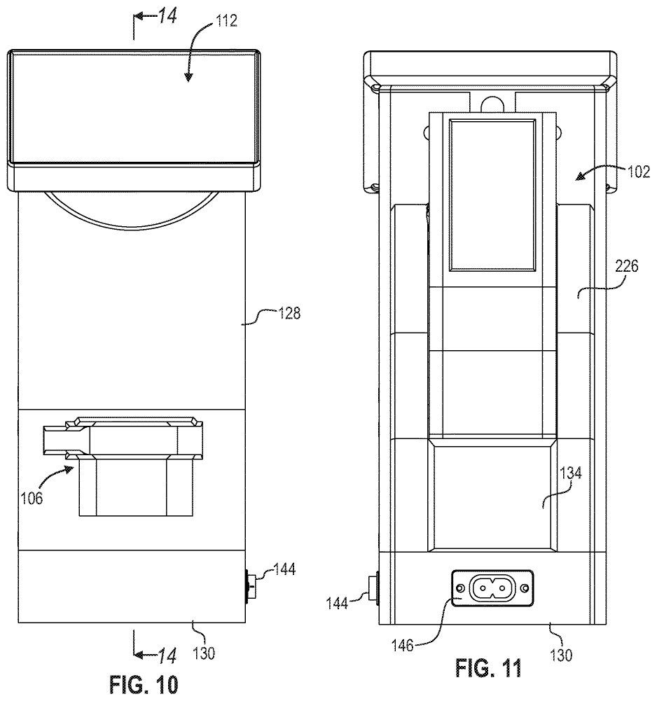

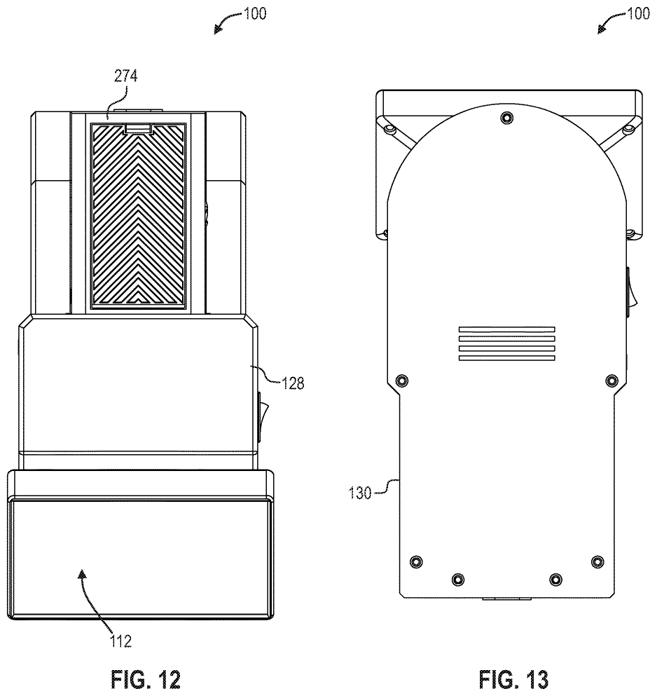

### DETAILED DESCRIPTION OF THE PREFERRED EMBODIMENTS

Referring now to the drawings, like reference numerals designate identical or corresponding features throughout the several views.

With reference to the several drawings, implementations of an automatic contact loader apparatus are shown generally at 100. The automatic contact loader apparatus 100 may also be referred to as the apparatus 100.

Anywhere a letter is used in conjunction with a reference number in the present specification and drawings, it is intended to identify a specific instance of the general case. For example, a magazine retention boss is shown generally at 230 and specific instances of the magazine retention boss 230 may be denoted at 230a and 230b. In certain implementations of the apparatus 100, each of these instances may be structurally identical to one another while in other implementations the feature sets may differ from one another.

In the present specification, unless the particular nature of a fastener is described or claimed, the term fastener may be used to denote fastening by way of adhesion, a rivet, a bolt, a screw, a nail, a nut, some combination thereof, or the like.

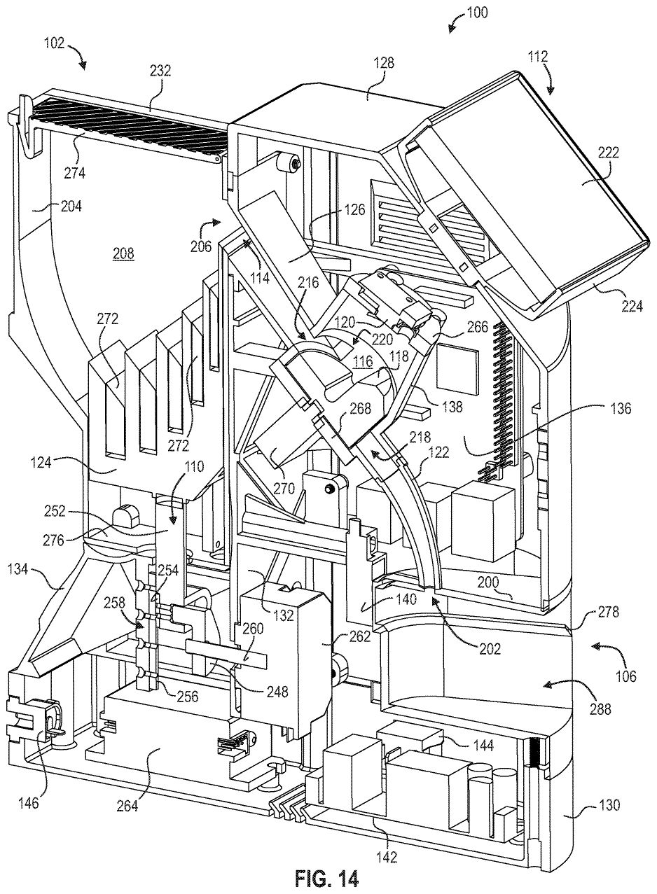

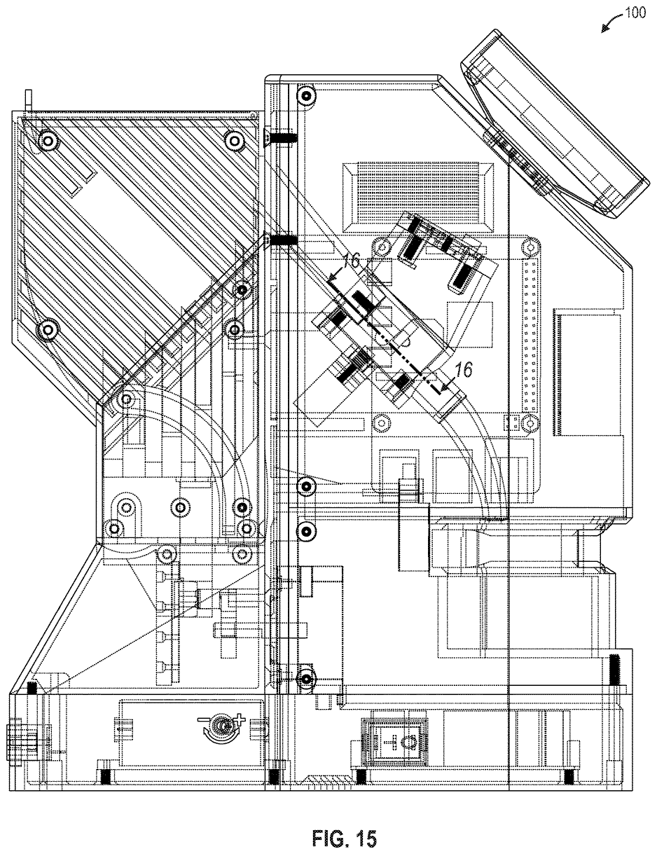

Referring to FIGS. 14, 20, and 29, certain implementations of an automatic contact loader apparatus 100 for a handheld crimper tool 300 may comprise a magazine receptacle 104 having a contact inlet window 114. The apparatus 100 may include a tool receptacle 106 to receive a crimping portion 302 of the handheld crimper tool 300. In some implementations of the apparatus 100, the tool receptacle 106 may include a tool positioner relief 288. The tool positioner relief 288 may accommodate varieties of handheld crimper tools 300 with a tool contact positioner 338. The tool receptacle 106 may have an upper portion 200 having a contact dispense port 202. The contact dispense port 202 may be in alignment with a tool contact aperture 303 of the crimping portion 302 when the crimping portion 302 is received by the tool receptacle 106.

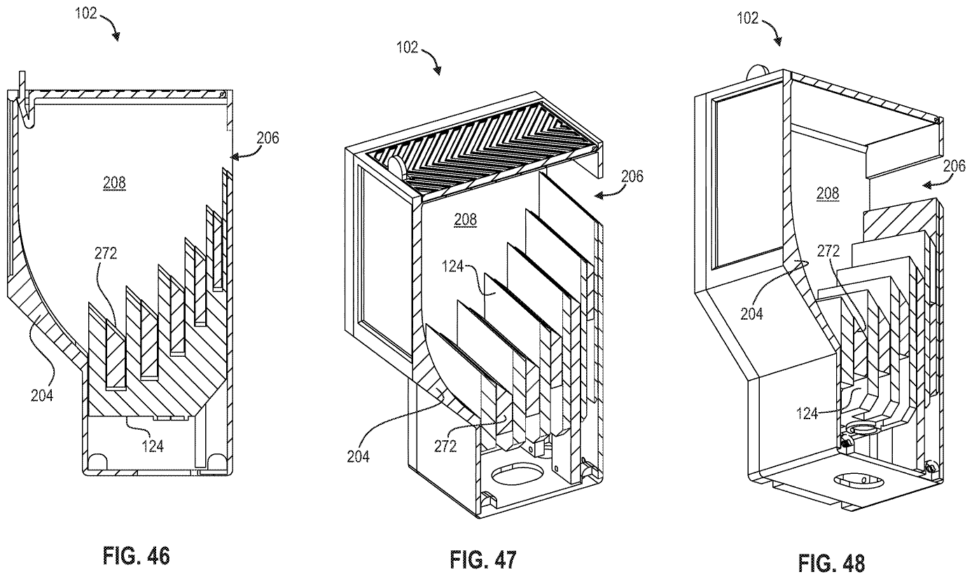

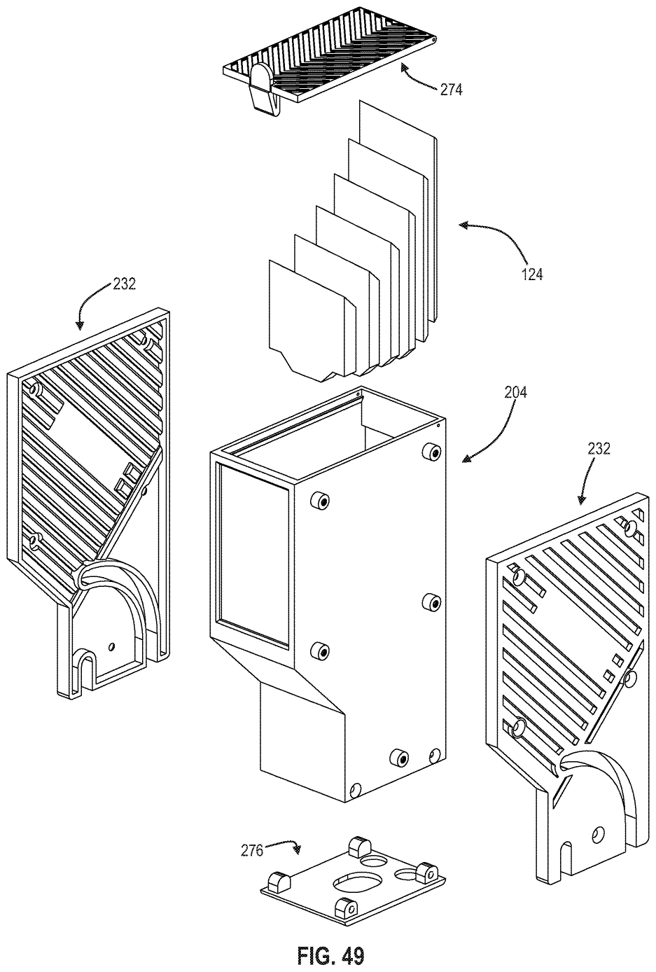

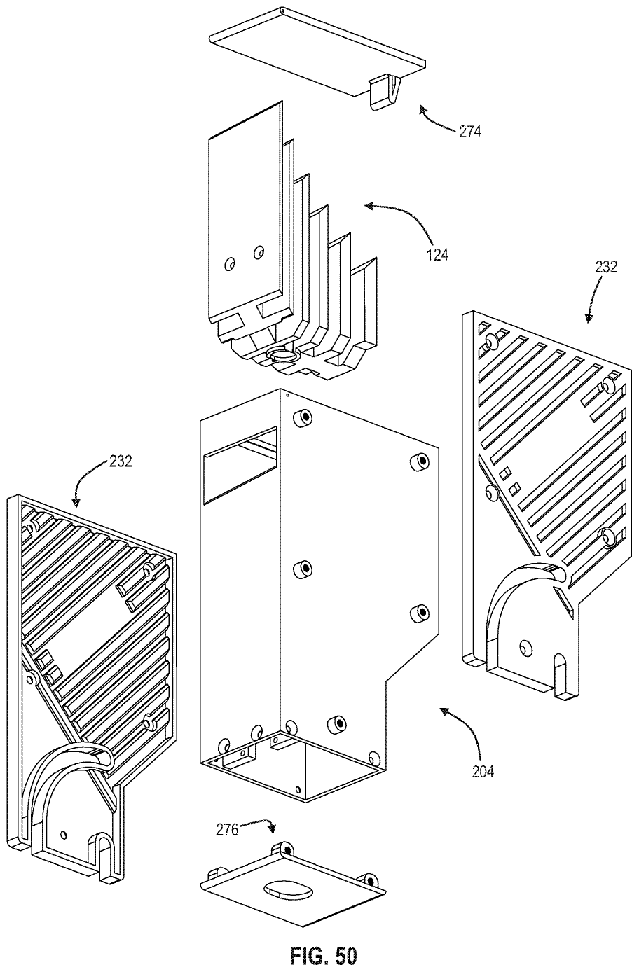

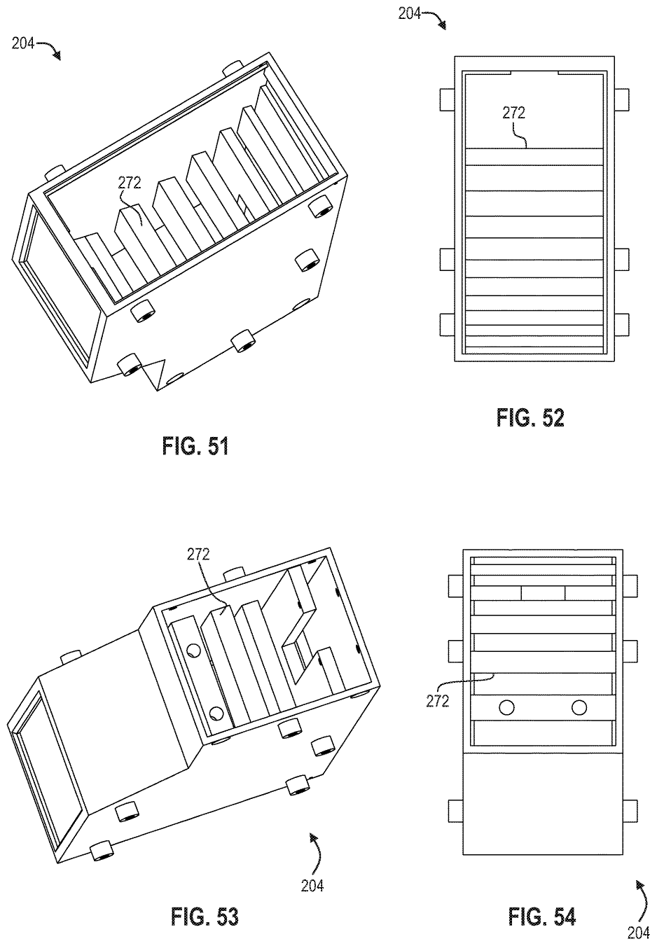

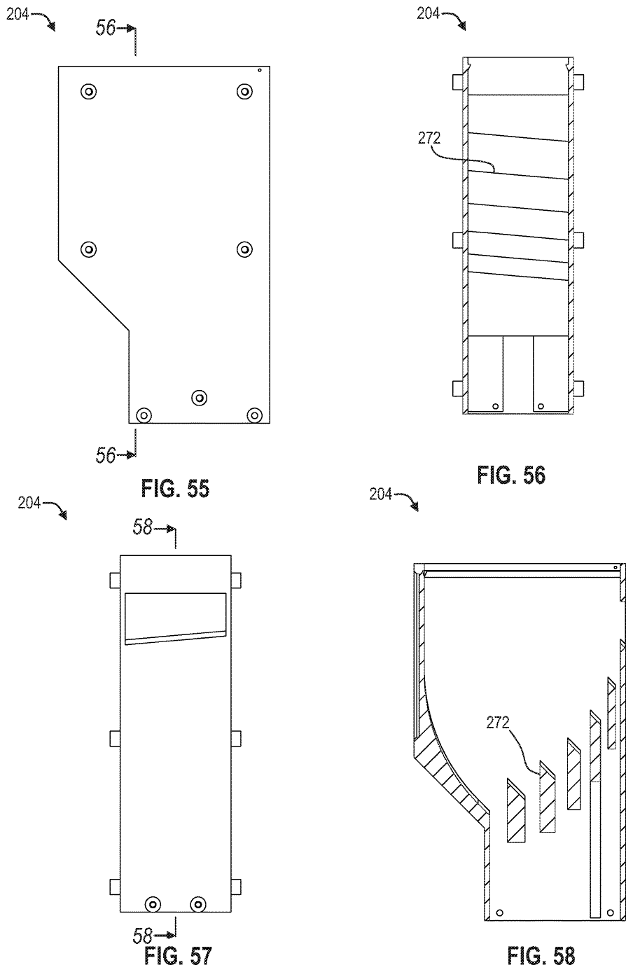

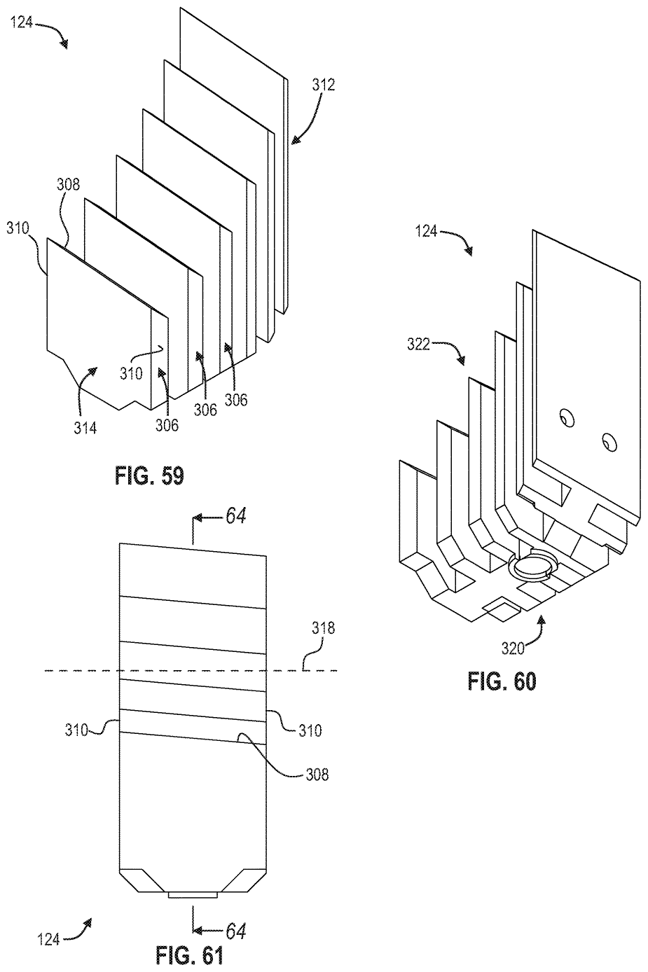

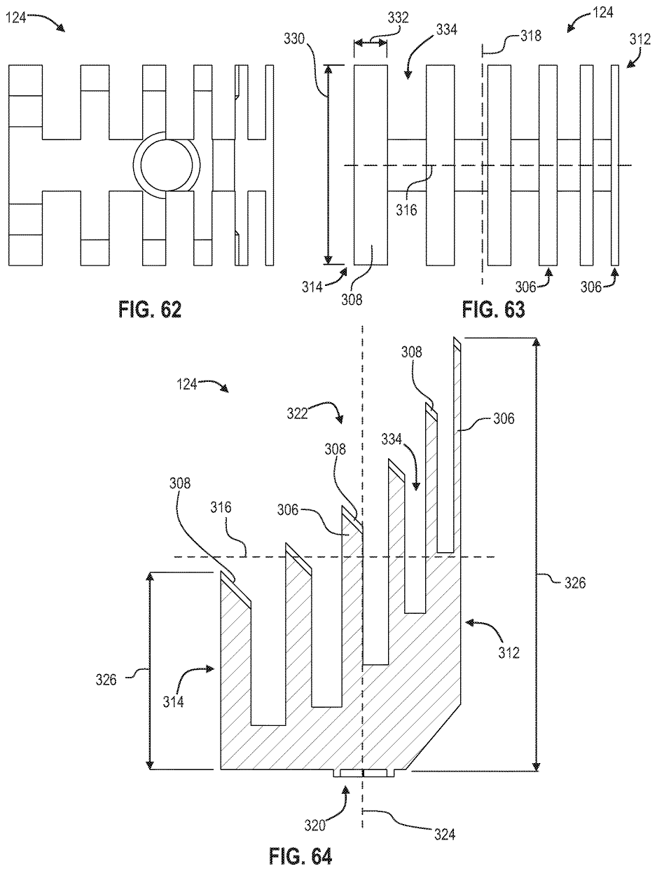

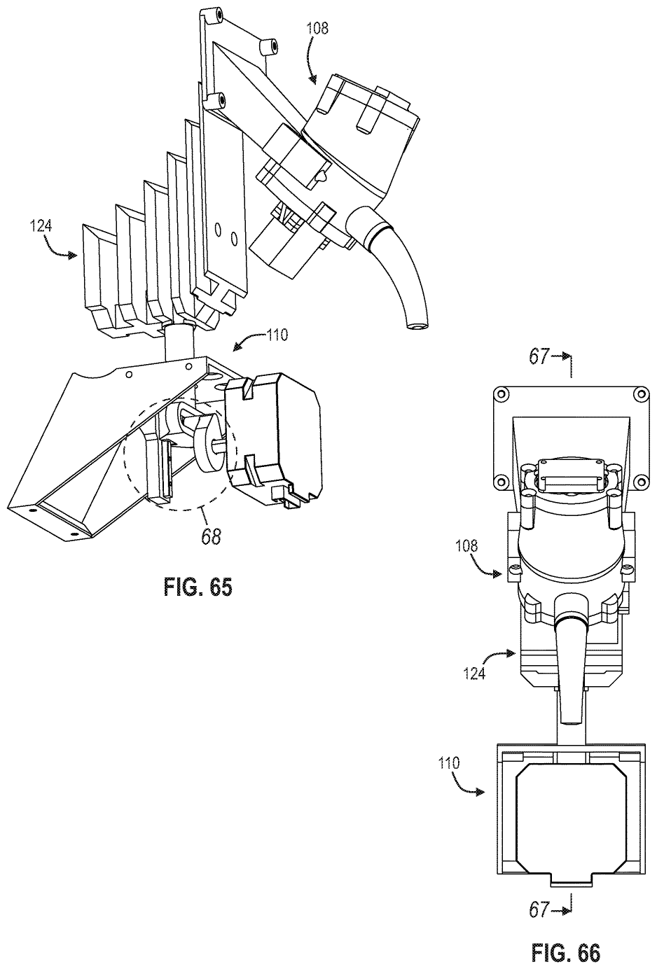

Referring to FIGS. 14 and 46-49, particular implementations of the apparatus may comprise a contact magazine 102. The contact magazine 102 may include a magazine housing 204. The contact magazine 102 may comprise a contact storage chamber 208 defined within the magazine housing 204 for storing a supply of electrical contacts 210. The contact magazine 102 may have a contact discharge gate 206. The contact discharge gate 206 may be in contact feeding communication with the contact inlet window 114 when the contact magazine 102 is in magazine mounted engagement with the magazine receptacle. The contact feeding communication may be defined as, for example, where the contact discharge gate 206 is aligned with the contact inlet window in order to, for example, create a mutually aligned opening for electrical contacts 210 to travel through. In some implementations of the apparatus 100, the contact magazine 102 may be placed into and out of magazine mounted engagement with the magazine receptacle 104.

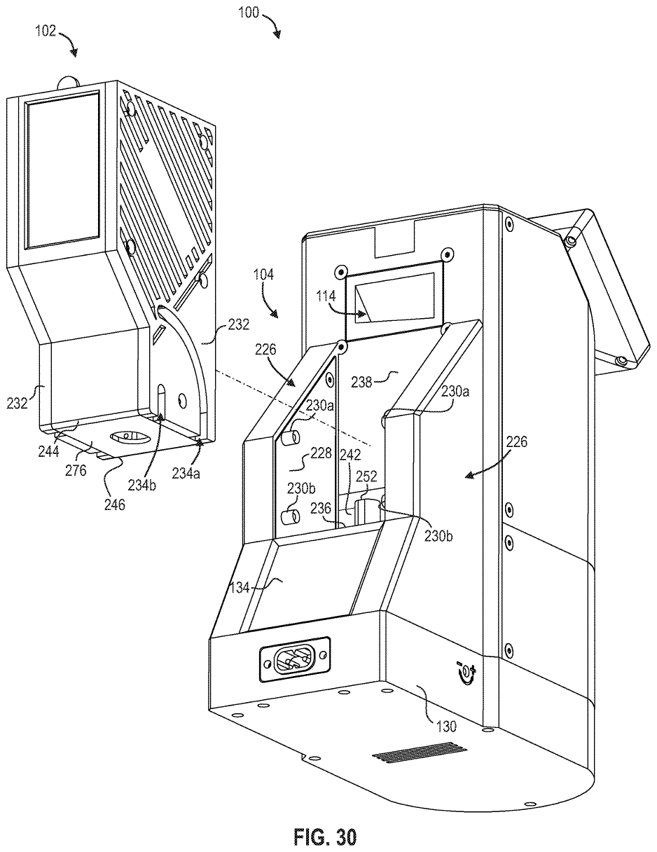

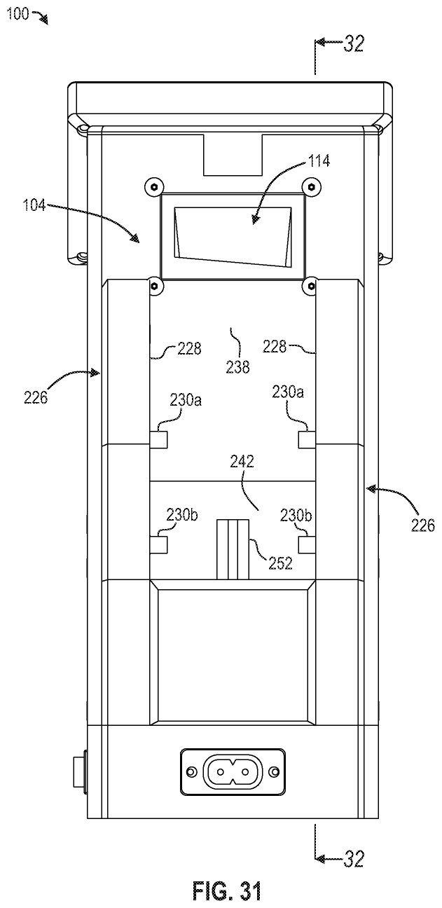

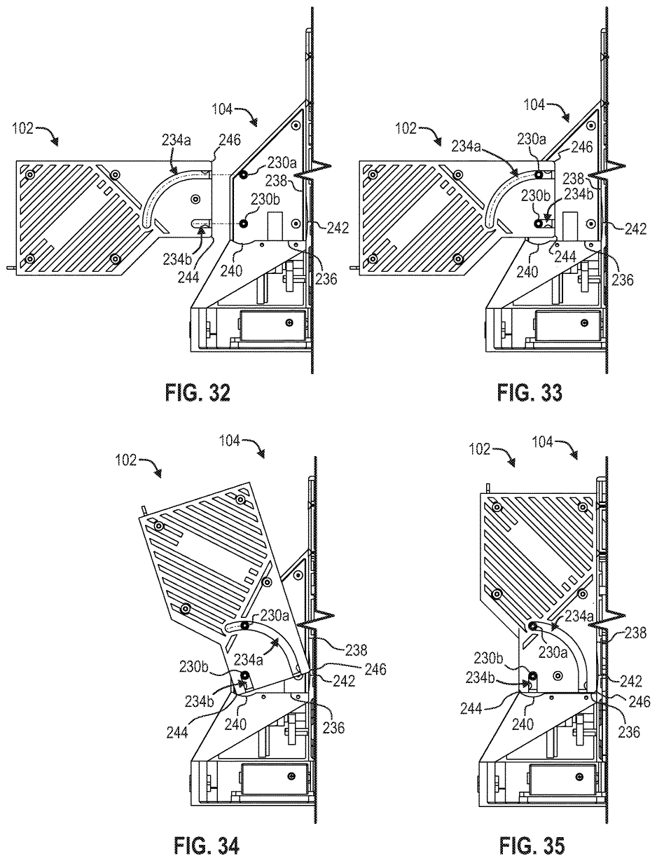

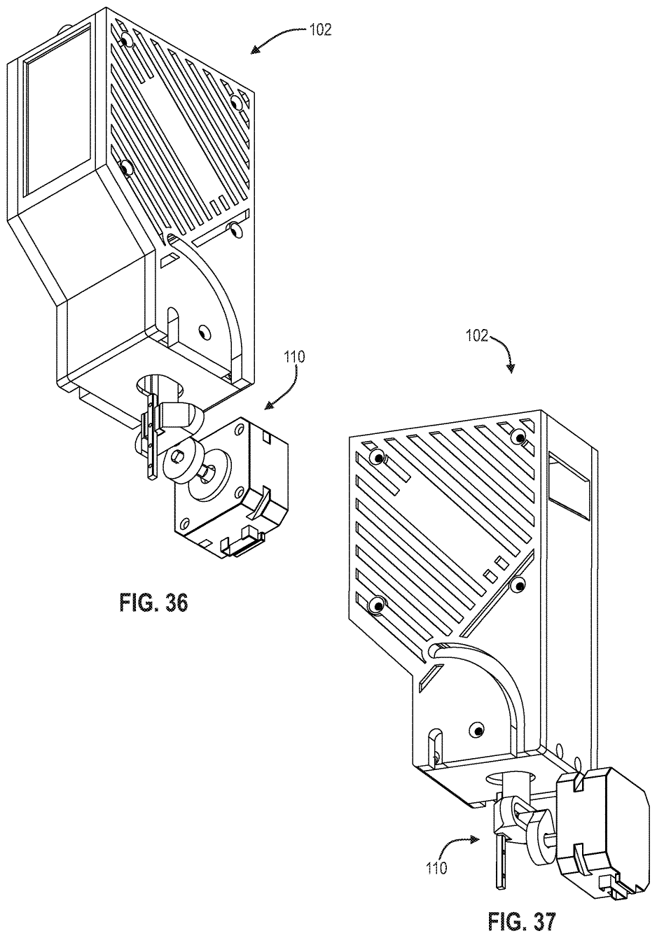

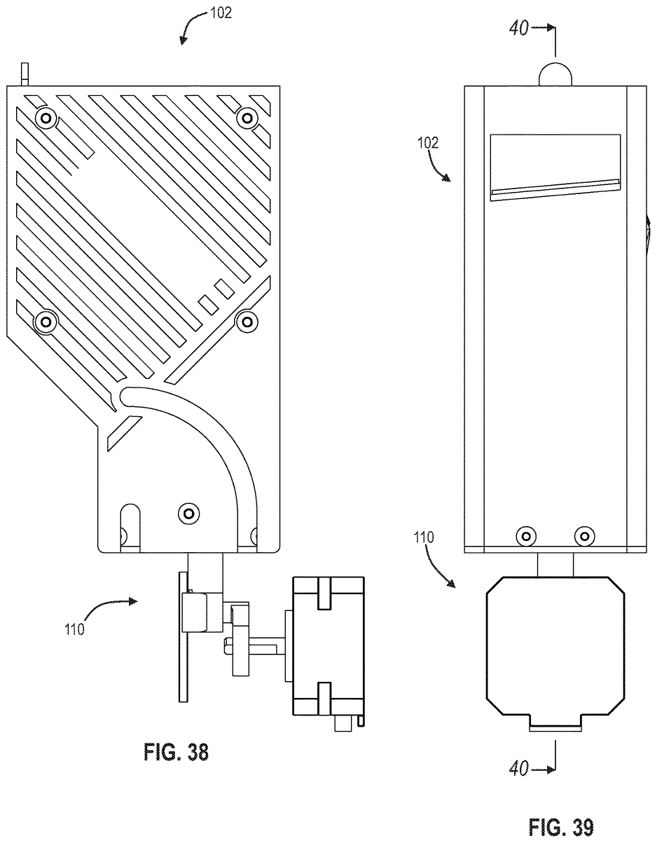

Referring to FIGS. 32-35, in particular implementations of the apparatus 100, the magazine mounted engagement may at least be in part by way of complementary engagement between a plurality of magazine retention bosses 230 and a plurality of receptacle engagement grooves 234. The magazine receptacle 104 may comprise a pair of lateral engagement walls 226 (see, for example, FIG. 31). The contact magazine 102 may comprise a pair of magazine lateral panels 232 (see, for example, FIG. 30). The magazine retention bosses 230 may protrude from the lateral engagement walls 226 and the receptacle engagement grooves 234 may be disposed in the magazine lateral panels 232, while in other implementations of the apparatus 100, the reverse may be true.

In some implementations of the apparatus 100, the contact magazine 102 may be moved between a first engagement position and a second engagement position with respect to the magazine receptacle 104. When the contact magazine 102 is in the second engagement position, the contact magazine 102 may be in the magazine mounted engagement. Movement of the contact magazine 102 between the first engagement position to the second engagement position may require the contact magazine 102 to pivotably rotate with respect to the magazine receptacle 104.

The receptacle engagement grooves 234 may comprise a set of arcuate receptacle engagement grooves 234a. The magazine retention bosses 230 may comprise a set of first magazine retention bosses 230a. The movement of the contact magazine 102 between the first engagement position and the second engagement position may involve the first magazine retention bosses 230a arcuately traveling within the arcuate receptacle engagement grooves 234a.

The magazine retention bosses 230 may include a set of second magazine retention bosses 230b. In some implementations of the apparatus 100, the second magazine retention bosses 230b may be linearly shaped. During the movement of the contact magazine 102 between the first engagement position and the second engagement position, the pivotable rotation of the contact magazine 102 may be about the second magazine retention bosses 230b.

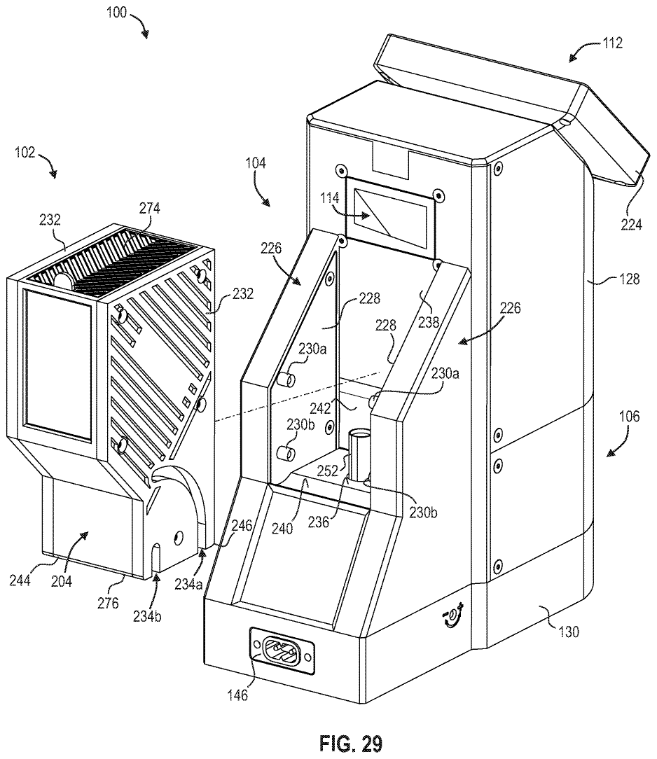

Referring to FIG. 29, in particular implementations of the apparatus 100, the magazine receptacle 104 may include a floor wall 236. The floor wall 236 may have a magazine rearward edge relief 240. The magazine receptacle may have a rear wall 238. The rear wall 238 may have a magazine forward edge relief 242. The contact magazine 102 may include a rearward bottom edge 244 and a forward bottom edge 246. Referring to FIG. 34, during the movement from the first engagement position to the second engagement position, the forward bottom edge 246 may travel through the magazine forward edge relief 242. The rearward bottom edge 244 may travel through the magazine rearward edge relief 240. The contact magazine 102 may, for example, avoid interference with the floor wall 236 and the rear wall 238 by way of the magazine rearward edge relief 240 and the magazine forward edge relief 242.

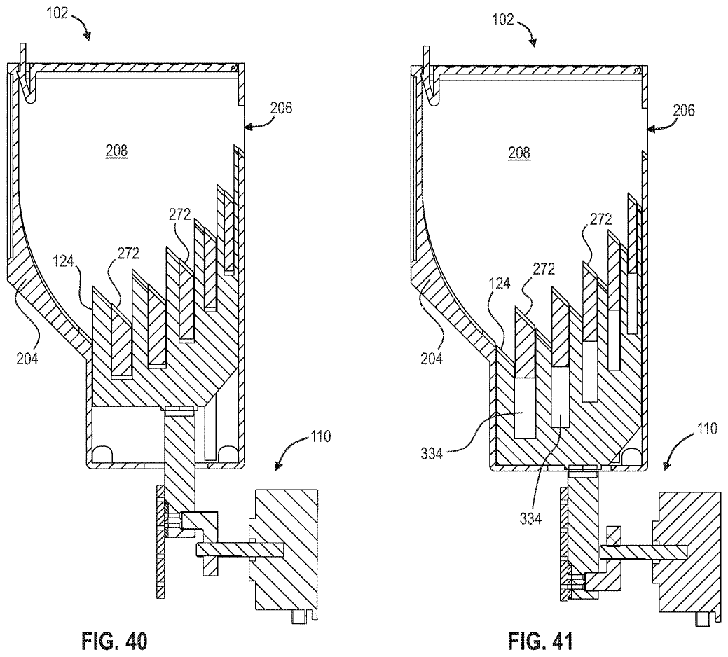

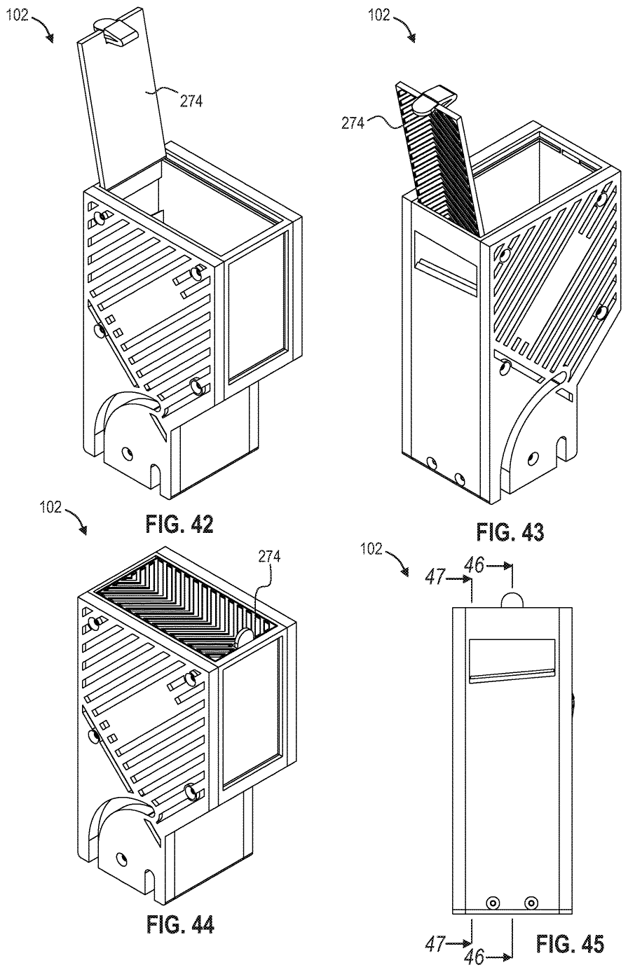

Referring to FIGS. 40 and 41, in certain implementations of the apparatus 100, the contact magazine 102 may include a conveyor 124. The conveyor 124 may be actuatable to sequentially conveyingly transport discrete said electrical contacts 210 from the contact storage chamber 208 to the contact discharge gate 206. The apparatus 100 may include a conveyance actuation subsystem 110 activatable to actuate the conveyor 124. The conveyor 124 may be movable with respect to the magazine housing 204 between a conveyor upper position and a conveyor lower position. In some implementations of the apparatus 100, actuating the conveyor may start cyclical movement of the conveyor between the conveyor upper position and the conveyor lower position until the conveyor is deactivated. In some such implementations of the apparatus 100, the conveyor 124 may not stop until a discrete electrical contact 210 has traveled through the contact discharge gate 206, is manually deactivated, an error occurs, some combination thereof, or the like.

Referring to FIGS. 63 and 64, in particular implementations of the apparatus 100, the conveyor 124 may include a conveyor forward end 312 and a conveyor rearward end 314 disposed oppositely of one another. A conveyor longitudinal axis 316 may extend from the conveyor rearward end 314 to the conveyor forward end 312. An actuator engagement portion 320 and a conveyor upper portion 322 may be disposed oppositely of one another. A conveyor vertical axis 324 may extend from the conveyor upper portion 322 to the actuator engagement portion 320. A conveyor lateral axis 318 may be defined as extending orthogonally to the conveyor longitudinal axis 316 and the conveyor vertical axis 324.

In certain implementations of the apparatus 100, the conveyor 124 may include a plurality of conveyor stairs 306. Each of the conveyor stairs 306 may have a stair width 330. The stair width may be defined parallelly to the conveyor lateral axis 318. In some implementations of the apparatus 100, the stair widths 330 may incrementally decrease from the conveyor rearward end 314 to the conveyor forward end 312 (see, for example, FIGS. 128 and 132).

Each of the conveyor stairs 306 may have a stair thickness 332. The stair thickness 332 may be defined parallelly to the conveyor longitudinal axis 316. In some implementations of the apparatus 100, the stair thicknesses 332 may incrementally decrease from the conveyor rearward end 314 to the conveyor forward end 312

Each of the conveyor stairs 306 may have a contact engagement surface 308. At least a portion of the contact engagement surface 308 may be disposed at a stair height 326. The stair height 326 may be defined parallelly to the conveyor vertical axis from the actuator engagement portion 320. In some implementations of the apparatus 100, the stair heights 326 may incrementally increase from the conveyor rearward end 314 to the conveyor forward end 312. In particular implementations of the apparatus 100, the contact engagement surfaces 308 may be laterally sloped with respect to the conveyor lateral axis 318 (see, for example, FIG. 61). In certain implementations of the apparatus 100, the contact engagement surfaces 308 may be longitudinally sloped with respect to the conveyor longitudinal axis 316 (see, for example, FIG. 64).

The conveyor stairs 306 may be incrementally spaced along the conveyor longitudinal axis 316. A stator engagement interstice 334 may be defined between each pair of adjacent said conveyor stairs 306.

In particular implementations of the apparatus 100, the contact magazine 102 may comprise a plurality of stator elements 272. The stator elements 272 may be rigidly affixed to the magazine housing 204 (see, for example, FIG. 58) Referring to FIGS. 40 and 41, movement of the conveyor 124 between the conveyor upper position and the conveyor lower position may involve the stator elements 272 sliding within the stator engagement interstices 334.

Referring to FIGS. 135-136 and 139-140, a pair of lateral inboard walls may be defined within the magazine housing 204. In particular implementations of the apparatus 100, the lateral inboard walls may have a narrowing taper corresponding to the incremental decrease of the stair widths 330.

Certain implementations of the apparatus 100 may comprise a plurality of the contact magazines 102 and a plurality of the conveyors 124. At least one of the conveyors 124 may have the incremental decrease in stair widths 330 and at least one of the contact magazines 102 may have the corresponding narrowing taper. This may facilitate the use of, for example, a variety of electrical contacts 210.

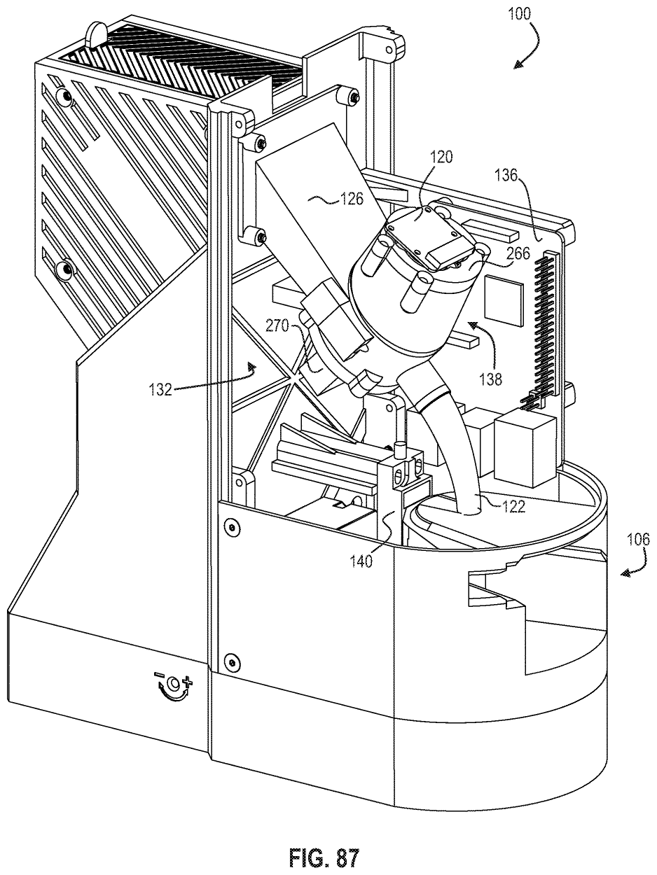

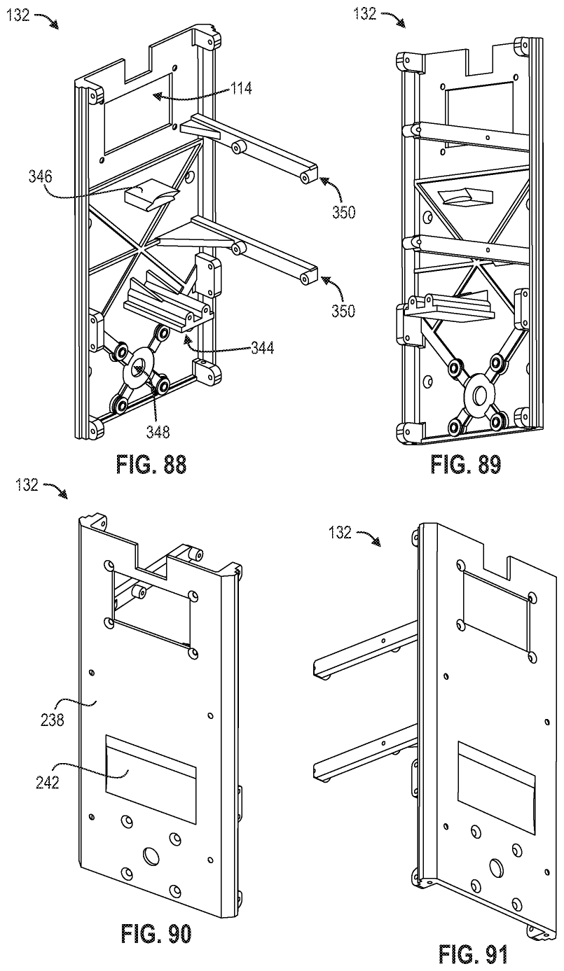

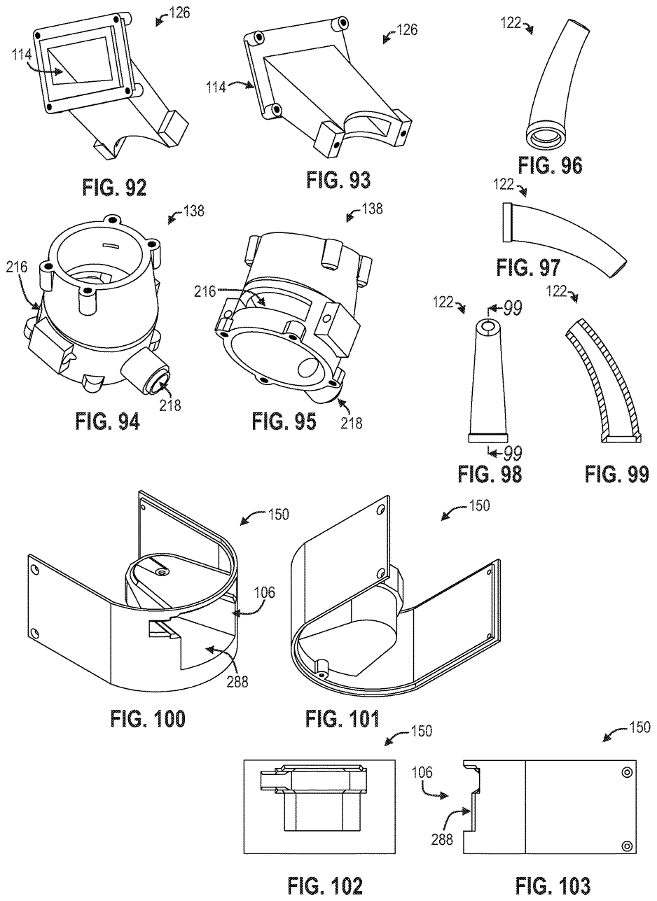

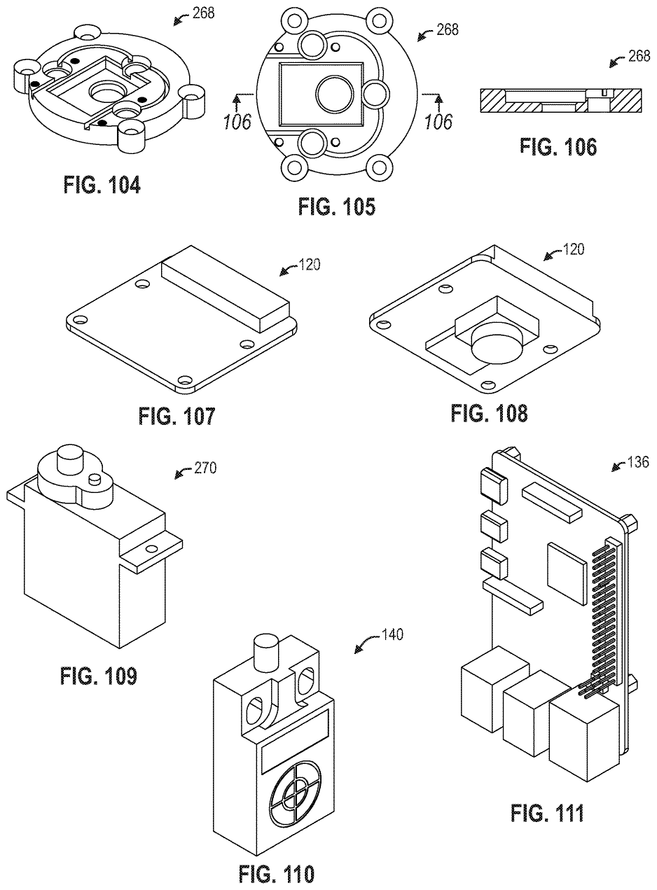

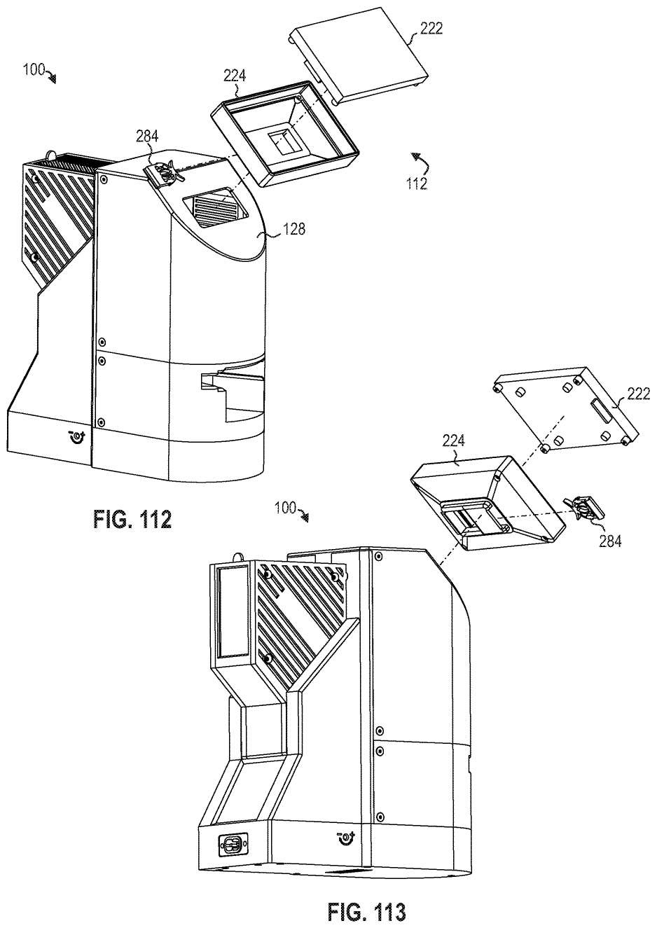

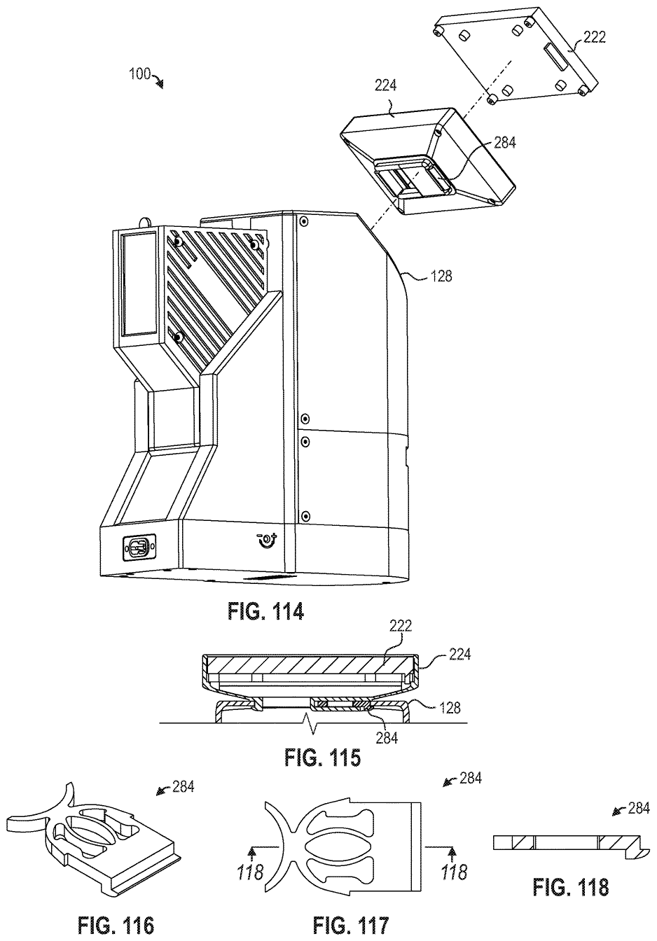

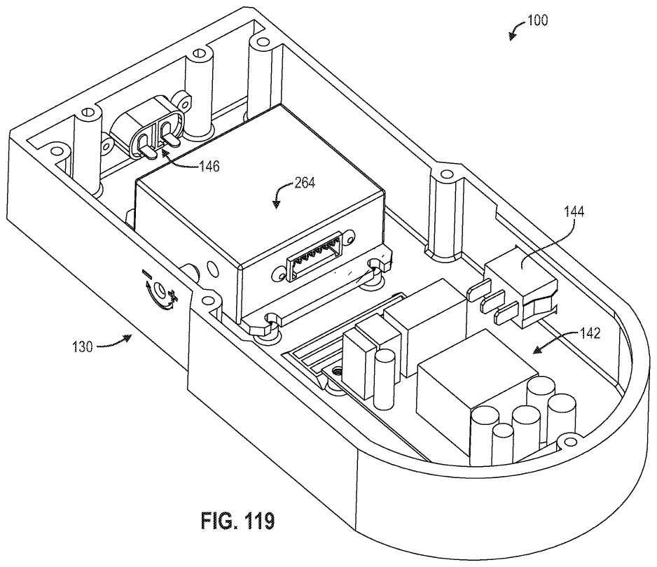

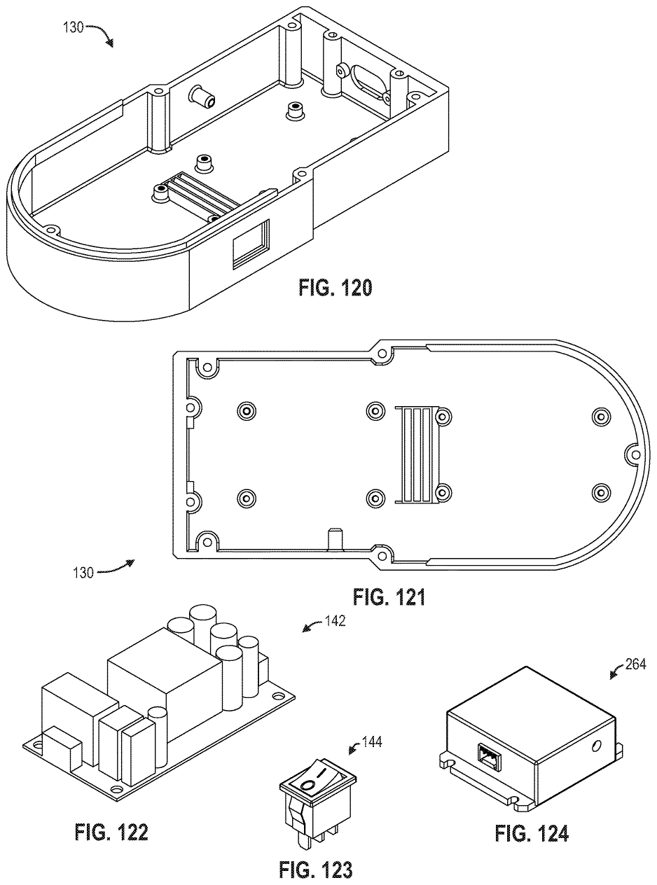

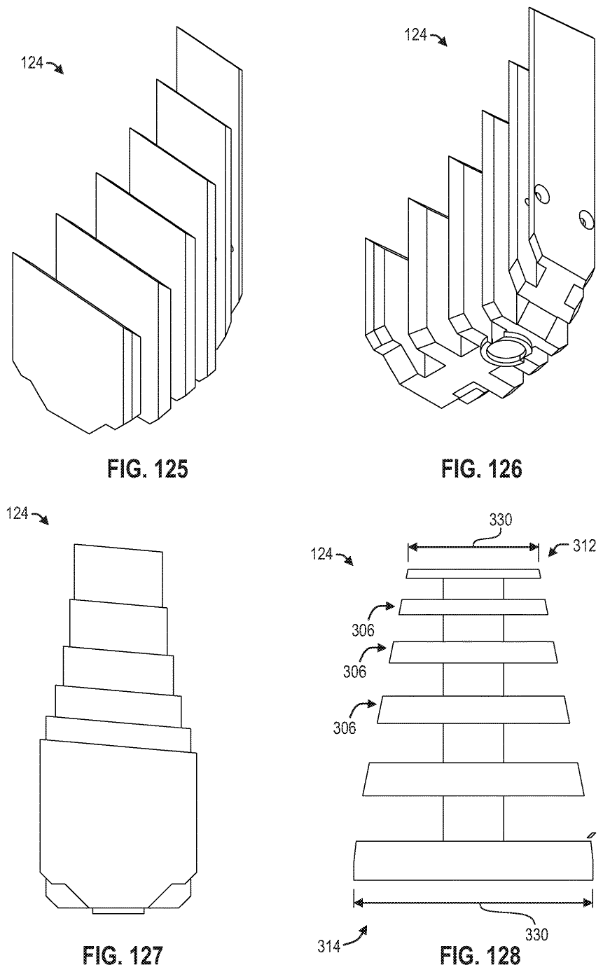

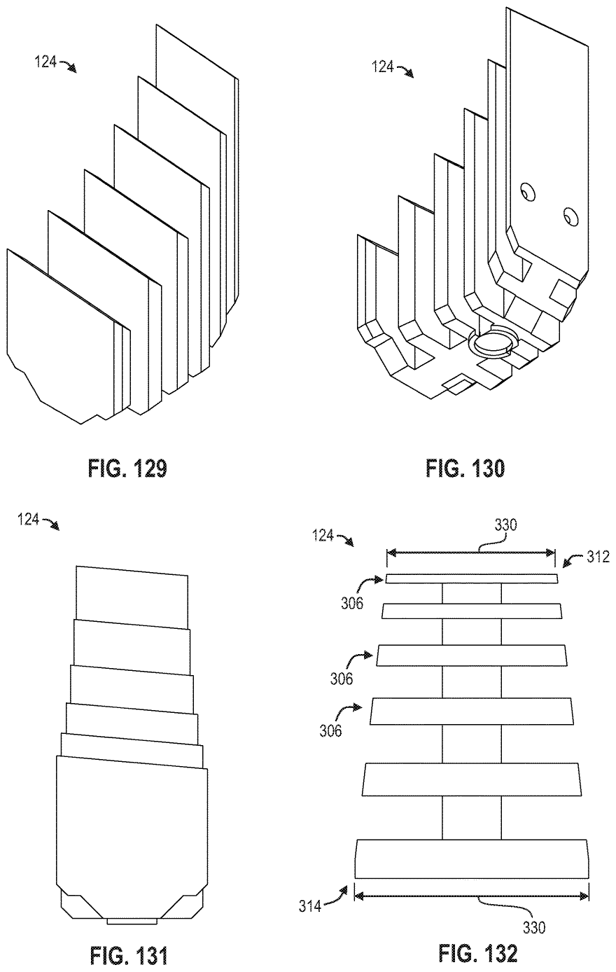

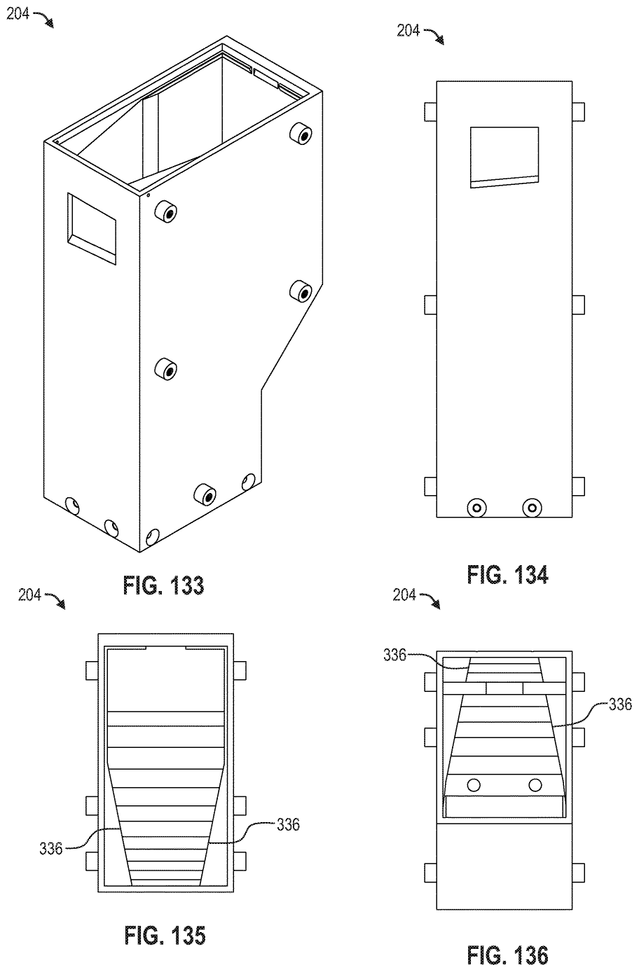

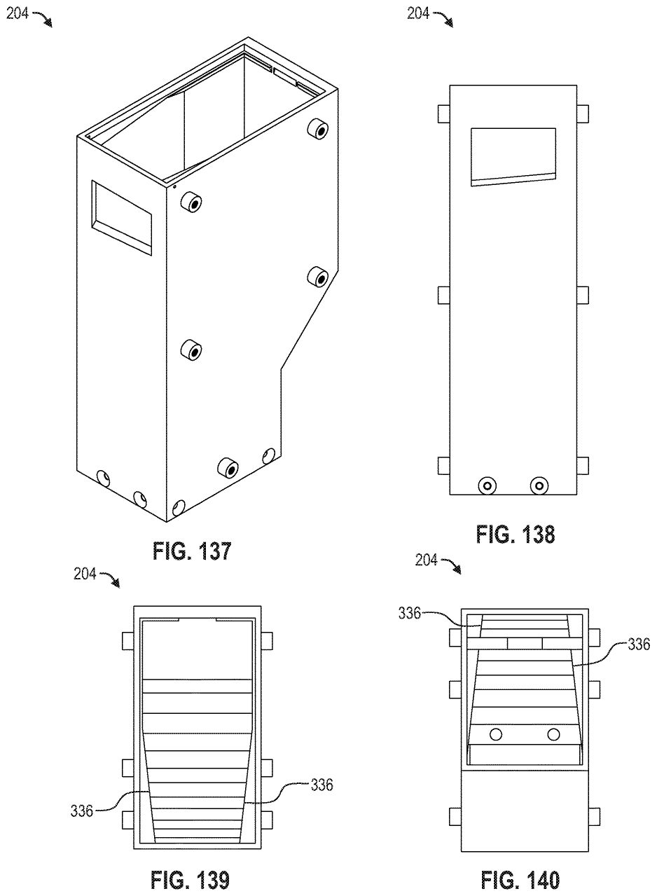

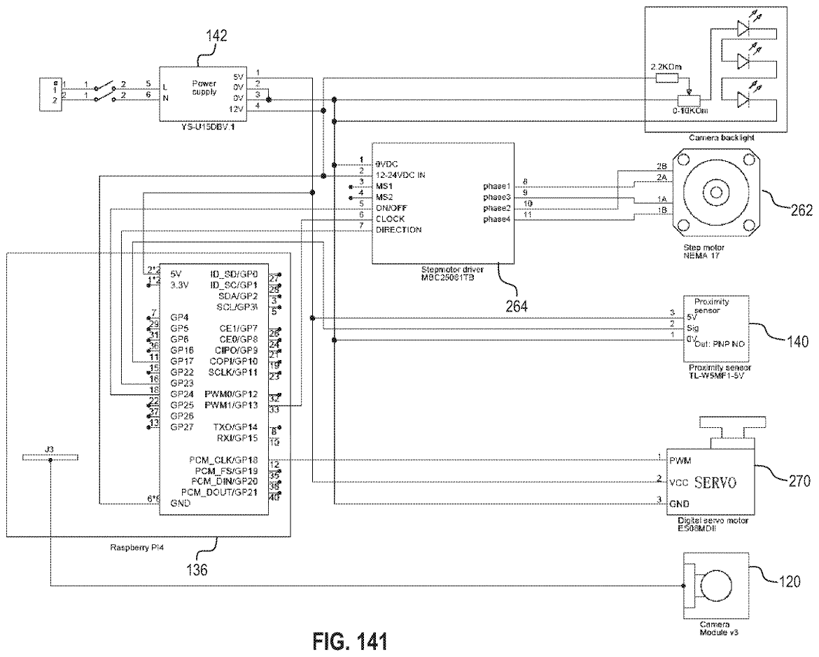

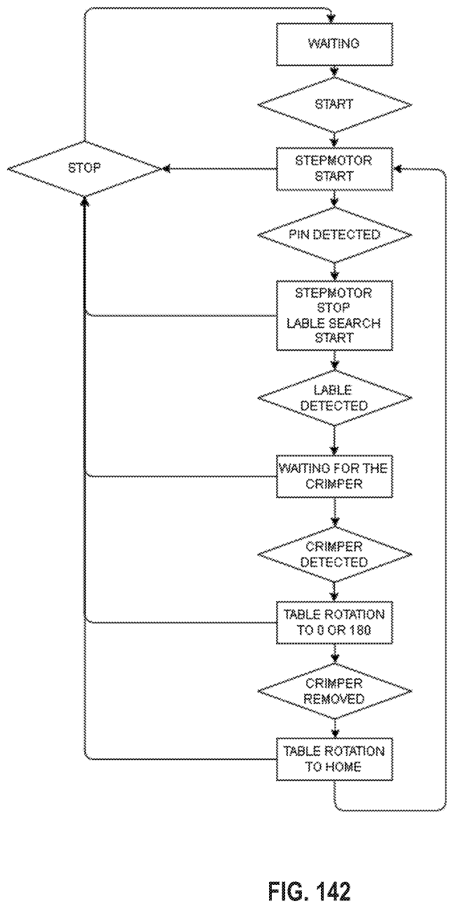

Referring to FIG. 14 and FIG. 87, in certain implementations of the apparatus 100, the contact magazine 102 may include a contact funnel 126 for guiding the discrete electrical contacts 210 from the contact inlet window 114 to a contact input port 216.

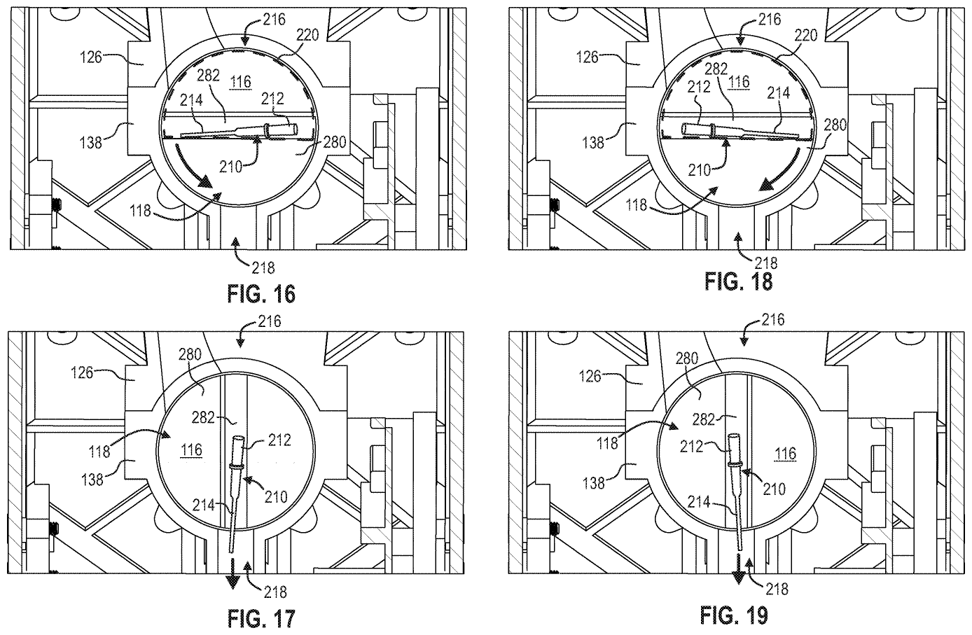

Referring to FIGS. 16-19, certain implementations of the apparatus may include a contact staging chamber 116. The contact staging chamber 116 may have a contact input port 216 and a contact release port 218. A contact turntable 118 may be disposed within the contact staging chamber 116. The contact turntable 118 may be in a contact staging orientation to receive a discrete electrical contact 210 from the contact input port 216. The contact turntable 118 may stage the discrete electrical contact 210 in a contact staging zone 220. The contact turntable 118 may be selectively commandable to rotate from the contact staging orientation to a first release orientation. In certain implementations, the contact turntable 118 may alternately or in addition be selectively commandable to rotate from the contact staging orientation to a second release orientation.

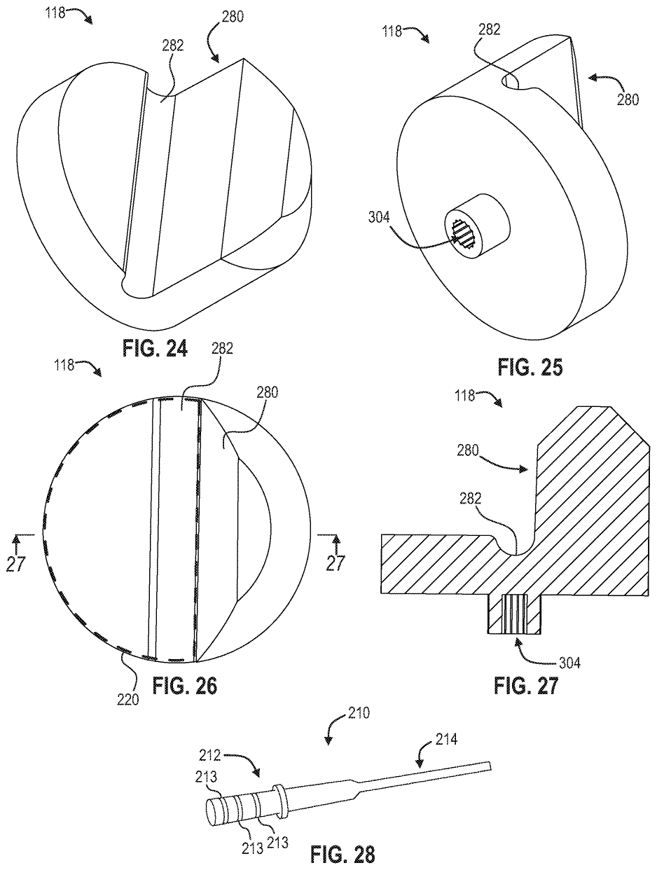

Referring to FIG. 24, in certain implementations of the apparatus 100, the contact turntable 118 may include a contact detent portion 280. Referring to FIGS. 16 and 18, when the discrete electrical contact 210 is staged in the contact staging zone 220 and the contact turntable 118 is in the contact staging orientation, the contact detent portion 280 may prevent the discrete electrical contact 210 in the contact staging zone 220 from entering the contact release port 218.

Referring to FIG. 14, particular implementations of the apparatus 100 may comprise a staging zone camera 120. The staging zone camera 120 may be directed toward the contact staging zone 220 to obtain staging zone image data. Referring to FIG. 28, an electrical contact 210 may have a wire barrel portion 212 and a mating portion 214. The electrical contact may include contact specification data 213 disposed thereon.

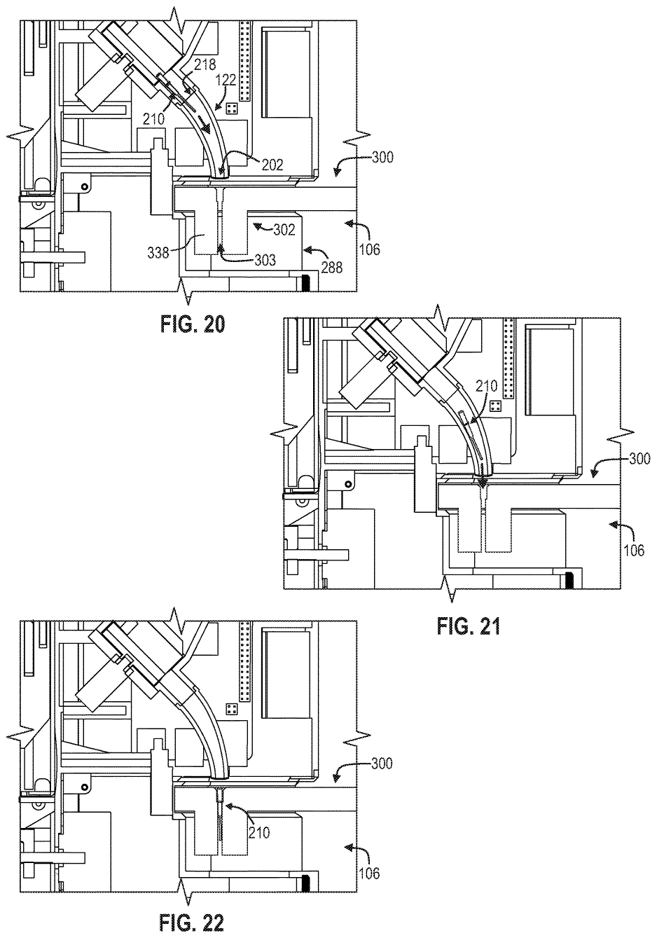

Referring to FIGS. 20-22, in some implementations of the apparatus 100, a dispense guide tube 122 may be in electrical contact guiding communication between the contact release port 218 and the contact dispense port 202.

Certain implementations of the apparatus 100 may comprise one or more processors communicatively coupled to a non-transitory memory. The non-transitory memory may store computer readable code that is operable, when executed by the one or more processors, to cause the one or more processors to execute a plurality of steps.

Referring to FIGS. 14 and 16-22, the steps may include activating the conveyance actuation subsystem 110. The steps may include detecting, by way of staging zone image data, presence of a discrete electrical contact 210 in the contact staging zone 220. The steps may include deactivating, responsive to the detecting, the conveyance actuation subsystem 110. The steps may include sensing receipt of the crimping portion 302 of the handheld crimper tool 300 within the tool receptacle 106. Certain implementations of the apparatus 100 may comprise a tool proximity sensor 140. The step of sensing may be by way of receiving a tool receipt signal from the tool proximity sensor 140.

The steps may include determining, by way of the staging zone image data, whether the discrete electrical contact 210 present in the contact staging zone 220 is in a first staged orientation or a second staged orientation. The steps may include, if the crimping portion 302 is sensed within the tool receptacle 106 and the discrete electrical contact 210 is in the first staged orientation, commanding the contact turntable 118 to rotate to the first release orientation. The steps may include, if the crimping portion 302 is sensed within the tool receptacle 106 and the discrete electrical contact 210 is in the second staged orientation, commanding the contact turntable 118 to rotate to the second release orientation. In some implementations, the first release orientation may be 180 angular degrees opposite of the second release orientation.

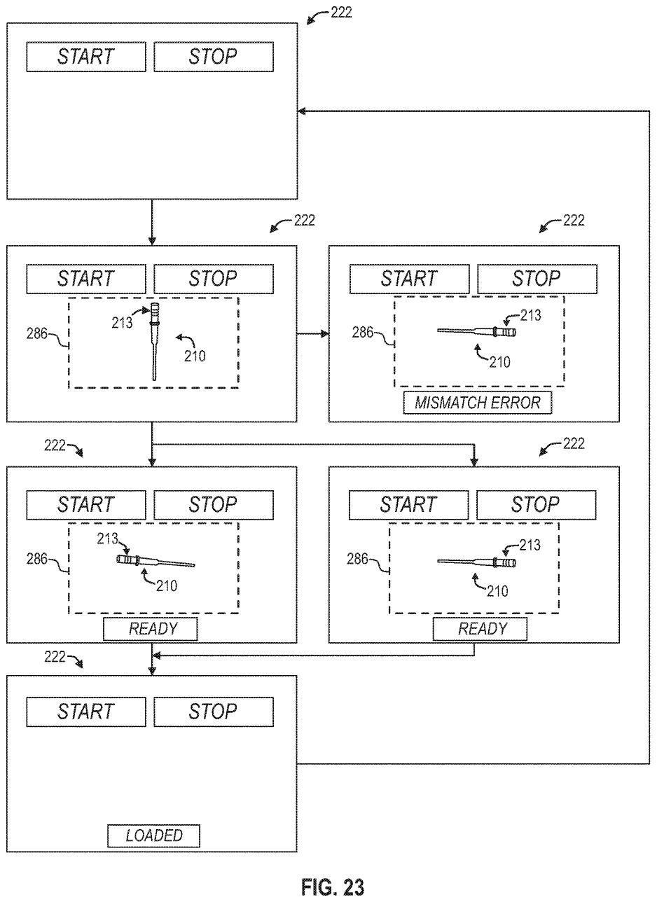

Referring to FIG. 23, particular implementations of the apparatus 100 may comprise a display monitor 222. The staging zone image data may include a photographic image 286 of the discrete electrical contact 210 in the contact staging zone 220. The steps may include transmitting the photographic image 286 to the display monitor 222 to be displayed.

The steps may include after the step of detecting, searching, by way of the staging zone image data, for contact identification information disposed on the discrete electrical contact 210 in the contact staging zone 220. The contact identification information may include contact specification data 213 for the discrete electrical contact 210 in the contact staging zone 220. The steps may include transmitting all or a portion of the contact identification information to the display monitor 222 to be displayed.

In certain implementations of the apparatus 100, the steps may include receiving user input specification data and determining if the contact specification data 213 matches the user input specification data. The steps may include, if the contact specification data 213 does not match the user input specification data, generating a contact mismatch error alert. The steps may include, before the step of commanding, transmitting the contact mismatch error alert to the display monitor 222 to be displayed.

The steps may include, if the presence of a discrete electrical contact 210 in the contact staging zone 220 is detected, transmitting a ready alert to the display monitor 222 to be displayed. The steps may include, if the turntable is commanded to rotate to a first release orientation or a second release orientation, transmitting a loaded alert to the display monitor 222 to be displayed.

In particular implementations of the apparatus 100, the steps may include tracking an amount of electrical contacts 210 dispensed from the apparatus 100 over a user-selected period of time.

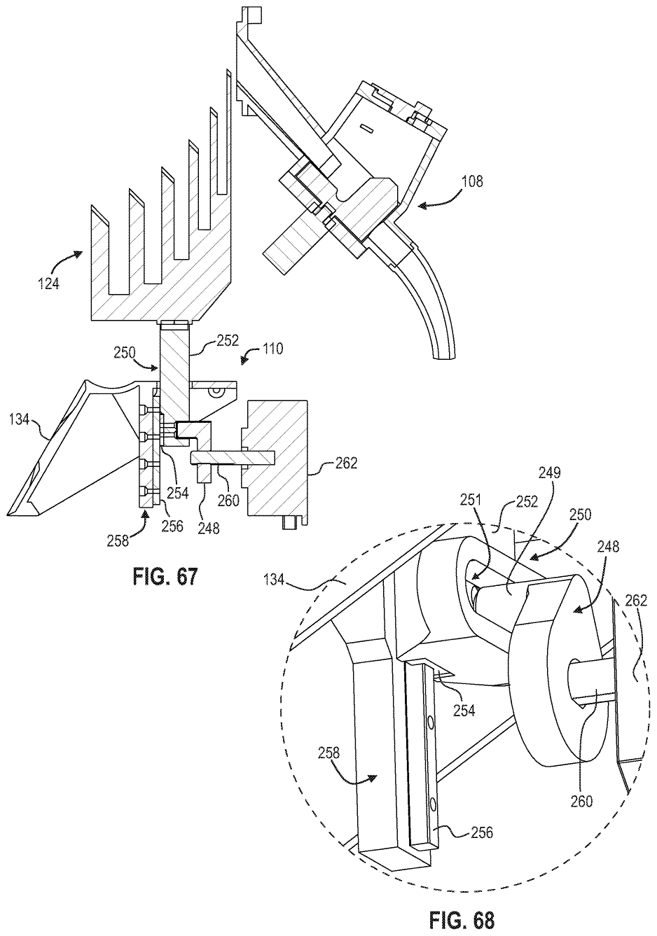

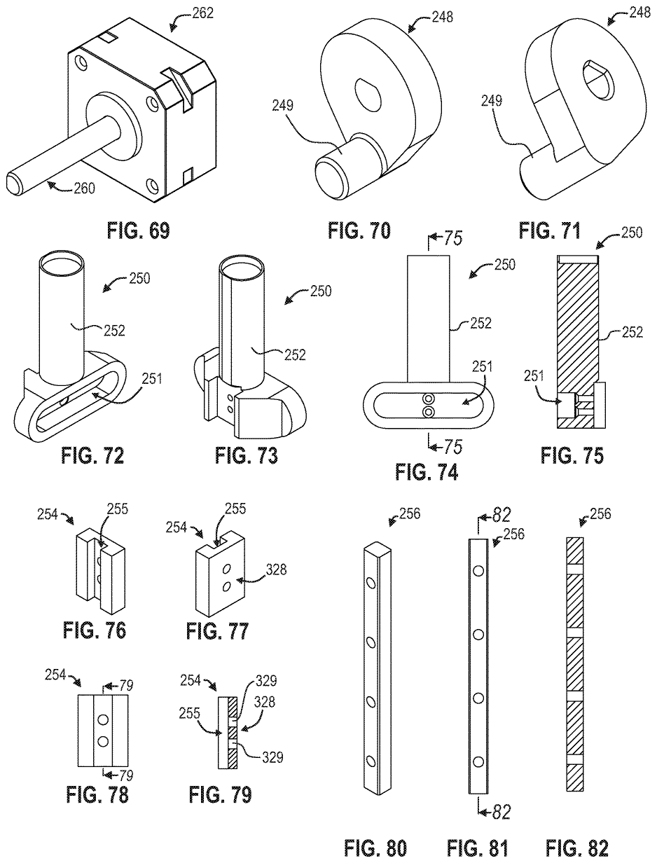

Referring to FIGS. 67 and 68, in certain implementations of the apparatus 100, the conveyance actuation subsystem 110 may comprise a stepper motor 262. The conveyance actuation subsystem 110 may include a cam element 248 in cam rotating communication with the stepper motor 262. The conveyance actuation subsystem 110 may have a cam follower element 250 in transported communication with the cam element 248. The transported communication may alternatively or in addition, in some implementations, be defined as motion converting communication. The cam follower element 250 may have a conveyor actuator 252 placed in actuating engagement with the conveyor 124. Referring to FIGS. 40 and 41, the actuation may cause movement, for example, the cyclical movement, of the conveyor 124 between the conveyor upper position and the conveyor lower position.

Referring to FIGS. 67 and 68, in particular implementations of the apparatus 100, the cam follower element 250 may include a cam engagement groove 251. The cam element 248 may include a follower engagement boss 249. The transported communication may involve the follower engagement boss 249 being slidably engaged within the cam engagement groove 251.

In certain implementations of the apparatus 100, the conveyance actuation subsystem 110 may include a carriage element 254. The carriage element 254 may have a guide groove 255 and a follower mounting portion 328 (see, for example, FIG. 79). The follower mounting portion 328 may be affixed to the cam follower element 250. The conveyance actuation subsystem 110 may include a guide rail 256. The movement of the conveyor 124 between the conveyor upper position and the conveyor lower position may involve the carriage element 254 linearly sliding on the guide rail 256 by way of the guide groove 255. In some implementations of the apparatus 100, the carriage element 254 and the guide rail 256 may each be comprised of metal to, for example, facilitate during cyclic loading a reduction of friction, a reduction of heat, a reduction of wear, an increase in precision, some combination thereof, or the like.

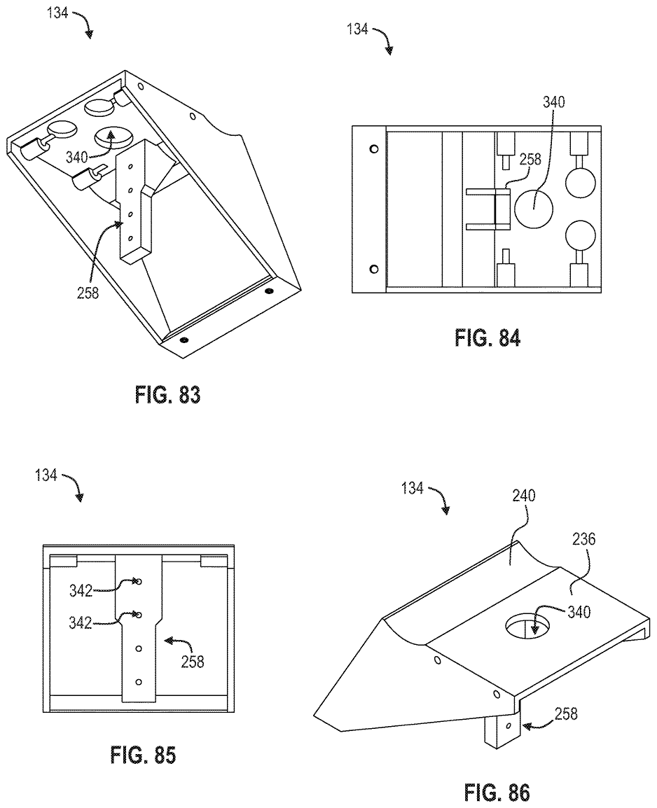

The conveyance actuation subsystem 110 may include a conveyance mount frame 134. The conveyance mount frame 134 may have a guide rail mount portion 258 (see, for example, FIG. 83). The guide rail 256 may be affixed to the guide rail mount portion 258.

In particular implementations of the apparatus 100, the stepper motor 262 may comprise a camshaft 260 which rotates when the conveyance actuation subsystem 110 is activated. The cam rotating communication may be by way of the cam element 248 being affixed to the camshaft 260.

In certain implementations of the apparatus 100, the contact magazine 102 may be placed into and out of magazine mounted engagement with the magazine receptacle 104. When the contact magazine 102 is in the magazine mounted engagement, the conveyor actuator 252 may be in the actuating engagement. When the contact magazine 102 is out of the magazine mounted engagement, the conveyor actuator 252 may be out of the actuating engagement.

Referring to FIGS. 14 and 87, particular implementations of the apparatus 100 may include a contact staging subsystem 108. The subsystem 108 may comprise a staging chamber housing 138 defining the contact staging chamber 116 therein. The subsystem 108 may include a contact turntable 118. The subsystem 108 may include a turntable motor 270, for example, to cause the rotation of the contact turntable 118. The subsystem 108 may include a staging zone camera 120. The staging zone camera may be in mounted engagement with the staging chamber housing 138.

Certain implementations of the apparatus 100 may accommodate a variety of machine style contacts, for example, size 12 AWG to 30 AWG. Particular implementations of the apparatus 100 may accommodate most machine style handheld crimper tools 300. Some implementations of the apparatus 100 may fit on most work benches to facilitate, for example, supporting multiple operators. Certain implementations of the apparatus 100 may include an automatic shutdown feature in case of malfunction, such as in the event of, for example, a contact mismatch error alert. In particular implementations of the apparatus 100, all functions of the apparatus 100 may be PLC controlled. Some implementations of the apparatus 100 may facilitate hands free operation, for example, no handling of loose electrical contacts 210.

Within this disclosure, different entities (which may variously be referred to as “elements,” “members,” “assemblies,” other components, etc.) may be described or claimed as “configured” to perform one or more tasks or operations. This formulation [entity] configured to [perform one or more tasks]-is used herein to refer to structure (i.e., something physical, such as a detent). More specifically, this formulation is used to indicate that this structure is arranged to perform the one or more tasks during operation. A structure can be said to be “configured to” perform some task even if the structure is not currently being operated. A “thrust bearing configured to facilitate an axial force transfer” is intended to cover, for example, a thrust bearing that has force transfer members which facilitate this axial force transfer during operation, even if the bearing in question is not currently being used (e.g., no load is currently being applied). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function and may be “configured to” perform the function after programming.

The following listing matches certain terminology used within this disclosure with corresponding reference numbers used in the non-limiting implementations illustrated in the several FIG.
100 automatic contact loader apparatus (for a handheld crimper tool)
102 contact magazine
104 magazine receptacle
106 tool receptacle
108 contact staging subsystem
110 conveyance actuation subsystem
112 display subsystem
114 contact inlet window
116 contact staging chamber
118 contact turntable
120 staging zone camera (e.g., Raspberry Pi Camera Module V2)
122 dispense guide tube
124 conveyor
126 contact funnel
128 front frame
130 bottom frame
132 middle frame
134 conveyance mount frame
136 computer element (e.g., single-board computer, e.g., Raspberry Pi 4)
138 staging chamber housing
140 tool proximity sensor (e.g., proximity sensor, e.g., TL-W5MF1-5V)
142 AC-DC converter module (e.g., 110-5-12v)
144 on-off switch
146 connector element (e.g., C8 plug adaptor)
148 contact clearance chamber
150 tool receptacle housing
200 upper portion (of tool receptacle)
202 contact dispense port
204 magazine housing
206 contact discharge gate (of contact magazine)
208 contact storage chamber (of contact magazine)
210 electrical contact
212 wire barrel portion (of elongated electrical contact)
213 contact specification data
214 mating portion (of elongated electrical contact)
216 contact input port (of contact staging chamber 116)
218 contact release port (of contact staging chamber 116)
220 contact staging zone (of contact staging chamber 116)
222 display monitor
224 monitor frame
226 lateral engagement wall (of pair of lateral engagement walls)
228 lateral engagement panel (of lateral engagement wall)
230 magazine retention boss (e.g., of lateral engagement panel)
230a first magazine retention boss (of pair or first magazine retention bosses)
230b second magazine retention boss (of pair of second magazine retention bosses)
232 magazine lateral panel (of contact magazine)
234 receptacle engagement groove (e.g., of magazine lateral panel)
234a arcuate receptacle engagement groove (e.g., having an arcuate alignment groove)
234b linear receptacle engagement groove (e.g., having a linear alignment groove)
236 floor wall (of magazine receptacle 104)
238 rear wall (of magazine receptacle 104)
240 magazine rearward edge relief (of floor wall)
242 magazine forward edge relief (of rear wall)
244 rearward bottom edge (of contact magazine)
246 forward bottom edge (of contact magazine)
248 cam element
249 follower engagement boss
250 cam follower element
251 cam engagement groove (of cam follower element)
252 conveyor actuator (of cam follower, e.g., a conveyor pusher rod)
254 carriage element
255 guide groove (of carriage element)
256 guide rail
258 guide rail mount portion (of conveyance mount frame)
260 camshaft
262 stepper motor
264 stepper motor driver (e.g., microstep stepper motor driver MBC25081TB)
266 staging camera mount
268 turntable motor mounting plate
270 turntable motor (e.g., metal gear digital servo, e.g., EMAX ES08MD II)
272 stator element (of magazine housing, e.g., built in)
274 magazine lid (of contact magazine)
276 magazine bottom panel
278 crimper guide groove (of tool receptacle)
280 contact detent portion (of contact turntable)
282 contact staging groove
284 monitor frame locker
286 photographic image (of staging zone image data)
288 tool positioner relief (of tool receptacle)
300 handheld crimper tool
302 crimping portion (of handheld crimper tool)
303 tool contact aperture (of crimping portion)
304 motor engagement aperture (of contact turntable)
306 conveyor stair
308 contact engagement surface (of conveyor stair)
310 stair lateral surface (of conveyor stair)
312 conveyor forward end (of conveyor)
314 conveyor rearward end (of conveyor)
316 conveyor longitudinal axis
318 conveyor lateral axis
320 actuator engagement portion (of conveyor)
322 conveyor upper portion (of conveyor)
324 conveyor vertical axis
326 stair height
328 follower mounting portion (of carriage element)
329 follower mounting aperture (of carriage element)
330 stair width
332 stair thickness
334 stator engagement interstice (of conveyor)
336 lateral inboard wall (of magazine housing)
338 tool contact positioner (of handheld crimper tool)
340 frame actuator aperture (of conveyance mount frame)
342 rail mounting apertures (of conveyance mount frame)
344 proximity sensor mounting portion (of middle frame)
346 turntable support element (of middle frame)
348 camshaft passage aperture (of middle frame)
350 computer mounting rail

While implementations of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An automatic contact loader apparatus for a handheld crimper tool, the apparatus comprising:
a magazine receptacle having a contact inlet window;
a tool receptacle configured to receive a crimping portion of the handheld crimper tool, an upper portion of the tool receptacle having a contact dispense port configured to be in alignment with a tool contact aperture of the crimping portion when the crimping portion is received by the tool receptacle;
a contact magazine including a magazine housing, a contact discharge gate configured to be placed in contact feeding communication with the contact inlet window, and a contact storage chamber defined within the magazine housing for storing a supply of elongated electrical contacts each having a wire barrel portion and a mating portion;
a contact staging chamber having a contact input port and a contact release port;
a contact turntable disposed within the contact staging chamber, the contact turntable being configured to be in a contact staging orientation to receive a discrete said electrical contact from the contact input port and stage the discrete electrical contact in a contact staging zone, the contact turntable being selectively commandable to rotate
(a) from the contact staging orientation to a first release orientation; and
(b) from the contact staging orientation to a second release orientation;
a staging zone camera directed toward the contact staging zone to obtain staging zone image data; and
a dispense guide tube in electrical contact guiding communication between the contact release port and the contact dispense port.

2. The apparatus of claim 1, wherein the contact magazine includes
a conveyor actuatable to sequentially conveyingly transport discrete said electrical contacts from the contact storage chamber to the contact discharge gate; and
a conveyance actuation subsystem activatable to actuate the conveyor.

3. The apparatus of claim 2, further comprising one or more processors communicatively coupled to a non-transitory memory, wherein the non-transitory memory stores computer readable code that is operable, when executed by the one or more processors, to cause the one or more processors to execute steps including:
activating the conveyance actuation subsystem;
detecting, by way of staging zone image data, presence of a discrete electrical contact in the contact staging zone;
deactivating, responsive to the detecting, the conveyance actuation subsystem;
sensing receipt of the crimping portion of the handheld crimper tool within the tool receptacle;
determining, by way of the staging zone image data, whether the discrete electrical contact present in the contact staging zone is in a first staged orientation or a second staged orientation;
if the crimping portion is sensed within the tool receptacle and the discrete electrical contact is in the first staged orientation, commanding the contact turntable to rotate to the first release orientation; and
if the crimping portion is sensed within the tool receptacle and the discrete electrical contact is in the second staged orientation, commanding the contact turntable to rotate to the second release orientation.

4. The apparatus of claim 3, wherein
the apparatus comprises a display monitor;
the staging zone image data includes a photographic image of the discrete electrical contact in the contact staging zone; and
the steps include
transmitting the photographic image to the display monitor to be displayed.

5. The apparatus of claim 3, wherein the steps include
after the step of detecting, searching, by way of the staging zone image data, for contact identification information disposed on the discrete electrical contact in the contact staging zone.

6. The apparatus of claim 5, wherein the contact identification information includes contact specification data for the discrete electrical contact in the contact staging zone.

7. The apparatus of claim 6, wherein
the apparatus comprises a display monitor; and
the steps include
transmitting all or a portion of the contact identification information to the display monitor to be displayed.

8. The apparatus of claim 6, wherein the steps include
receiving user input specification data;
determining if the contact specification data matches the user input specification data; and
if the contact specification data does not match the user input specification data, then generating a contact mismatch error alert.

9. The apparatus of claim 8, wherein
the apparatus comprises a display monitor; and
the steps include
before the step of commanding, transmitting the contact mismatch error alert to the display monitor to be displayed.

10. The apparatus of claim 3, wherein
the apparatus comprises a display monitor; and
the steps include
if the presence of a discrete electrical contact in the contact staging zone is detected, transmitting a ready alert to the display monitor to be displayed.

11. The apparatus of claim 3, wherein
the apparatus comprises a display monitor; and
the steps include
if the turntable is commanded to rotate to a first release orientation or a second release orientation, transmitting a loaded alert to the display monitor to be displayed.

12. The apparatus of claim 3, wherein the steps include
tracking an amount of electrical contacts dispensed from the apparatus over a user-selected period of time.

13. The apparatus of claim 3, wherein the first release orientation is 180 angular degrees opposite of the second release orientation.

14. The apparatus of claim 3, wherein the conveyance actuation subsystem comprises a stepper motor;
a cam element in cam rotating communication with the stepper motor; and
a cam follower element in transported communication with the cam element, the cam follower element having a conveyor actuator configured to be placed in actuating engagement with the conveyor;
wherein
the conveyor is movable with respect to the magazine housing between a conveyor upper position and a conveyor lower position; and
the actuation is configured to cause movement of the conveyor between the conveyor upper position and the conveyor lower position.

15. The apparatus of claim 14, wherein the cam follower element includes a cam engagement groove;
the cam element includes a follower engagement boss; and
the transported communication involves the follower engagement boss being slidably engaged within the cam engagement groove.

16. The apparatus of claim 14, wherein
the conveyance actuation subsystem includes
a carriage element having a guide groove and a follower mounting portion, the follower mounting portion being affixed to the cam follower element; and
a guide rail; and
the movement of the conveyor between the conveyor upper position and the conveyor lower position involves the carriage element linearly sliding on the guide rail by way of the guide groove.

17. The apparatus of claim 16, wherein the carriage element and the guide rail are each comprised of metal.

18. The apparatus of claim 16, wherein the conveyance actuation subsystem includes
a conveyance mount frame having a guide rail mount portion, the guide rail being affixed to the guide rail mount portion.

19. The apparatus of claim 14, wherein
the stepper motor comprises a camshaft configured to rotate when the conveyance actuation subsystem is activated; and
the cam rotating communication is by way of the cam element being affixed to the camshaft.

20. The apparatus of claim 14, wherein
the contact magazine is configured to be placed into and out of magazine mounted engagement with the magazine receptacle; and
when the contact magazine is in the magazine mounted engagement, the conveyor actuator is in the actuating engagement.

21. The apparatus of claim 1, wherein
the contact magazine is configured to be placed into and out of magazine mounted engagement with the magazine receptacle; and
when the contact magazine is in the magazine mounted engagement, the contact discharge gate is in the contact feeding communication.

22. The apparatus of claim 21, wherein the magazine mounted engagement is at least in part by way of complementary engagement between a plurality of magazine retention bosses and a plurality of receptacle engagement grooves.

23. The apparatus of claim 22, wherein
the magazine receptacle comprises a pair of lateral engagement walls;
the contact magazine comprises a pair of magazine lateral panels; and
the magazine retention bosses protrude from the lateral engagement walls and the receptacle engagement grooves are disposed in the magazine lateral panels.

24. The apparatus of claim 22, wherein
the contact magazine is configured to be moved between a first engagement position and a second engagement position with respect to the magazine receptacle; and
movement of the contact magazine between the first engagement position and the second engagement position requires the contact magazine to pivotably rotate with respect to the magazine receptacle.

25. The apparatus of claim 24, wherein
the receptacle engagement grooves comprise a set of arcuate receptacle engagement grooves;
the magazine retention bosses comprise a set of first magazine retention bosses; and
the movement of the contact magazine between the first engagement position and the second engagement position involves the first magazine retention bosses arcuately traveling within the arcuate receptacle engagement grooves.

26. The apparatus of claim 24, wherein
the magazine retention bosses include a set of second magazine retention bosses; and
during the movement of the contact magazine between the first engagement position and the second engagement position, the pivotable rotation of the contact magazine is about the second magazine retention bosses.

27. The apparatus of claim 24, wherein when the contact magazine is in the second engagement position, the contact magazine is in the magazine mounted engagement.

28. The apparatus of claim 24, wherein
the magazine receptacle includes
a floor wall having a magazine rearward edge relief; and
a rear wall having a magazine forward edge relief;
the contact magazine includes a rearward bottom edge and a forward bottom edge; and
during the movement from the first engagement position to the second engagement position
the forward bottom edge is configured to travel through the magazine forward edge relief; and
the rearward bottom edge is configured to travel through the magazine rearward edge relief.

29. The apparatus of claim 3, comprising a proximity sensor, wherein
the step of sensing is by way of receiving a tool receipt signal from the proximity sensor.

30. The apparatus of claim 2, wherein the conveyor includes
a conveyor forward end and a conveyor rearward end disposed oppositely of one another, a conveyor longitudinal axis extending from the conveyor rearward end to the conveyor forward end;
an actuator engagement portion and a conveyor upper portion disposed oppositely of one another, a conveyor vertical axis extending from the conveyor upper portion to the actuator engagement portion; and
a conveyor lateral axis defined as extending orthogonally to both the conveyor longitudinal axis and the conveyor vertical axis;
wherein the conveyor is movable with respect to the magazine housing between a conveyor upper position and a conveyor lower position.

31. The apparatus of claim 30, wherein the conveyor includes
a plurality of conveyor stairs, each of the conveyor stairs having
a stair width defined parallelly to the conveyor lateral axis;
a stair thickness defined parallelly to the conveyor longitudinal axis; and
a contact engagement surface, at least a portion of the contact engagement surface being disposed at a stair height defined parallelly to the conveyer vertical axis from the actuator engagement portion.

32. The apparatus of claim 31, wherein
the contact magazine comprises a plurality of stator elements;
the conveyor stairs are incrementally spaced along the conveyor longitudinal axis, a stator engagement interstice being defined between each pair of adjacent said conveyor stairs; and
movement of the conveyor between the conveyor upper position and the conveyor lower position involves the stator elements sliding within the stator engagement interstices.

33. The apparatus of claim 32, wherein the stator elements are rigidly affixed to the magazine housing.

34. The apparatus of claim 32, wherein the stair heights incrementally increase from the conveyor rearward end to the conveyor forward end.

35. The apparatus of claim 32, wherein the contact engagement surfaces are laterally sloped with respect to the conveyor lateral axis.

36. The apparatus of claim 32, wherein the contact engagement surfaces are longitudinally sloped with respect to the conveyor longitudinal axis.

37. The apparatus of claim 32, wherein the stair thicknesses incrementally decrease from the conveyor rearward end to the conveyor forward end.

38. The apparatus of claim 32, wherein the stair widths incrementally decrease from the conveyor rearward end to the conveyor forward end.

39. The apparatus of claim 38, wherein
a pair of lateral inboard walls are defined within the magazine housing, the lateral inboard walls having a narrowing taper corresponding to the incremental decrease of the stair widths.

40. The apparatus of claim 39, comprising a plurality of the contact magazines and a plurality of the conveyors, wherein
at least one of the conveyors has the incremental decrease in stair width; and
at least one of the contact magazines has the corresponding said narrowing taper.

41. The apparatus of claim 3, comprising a contact staging subsystem including
a staging chamber housing defining the contact staging chamber therein;
the contact turntable;
a turntable motor, for causing the rotation of the contact turntable; and
the staging zone camera in mounted engagement with the staging chamber housing.

42. The apparatus of claim 1, wherein
the contact turntable includes a contact detent portion; and
when the discrete electrical contact is staged in the contact staging zone and the contact turntable is in the contact staging orientation, the contact detent portion prevents the discrete electrical contact in the contact staging zone from entering the contact release port.

43. The apparatus of claim 1, wherein the contact magazine includes a contact funnel for guiding the discrete electrical contacts from the contact inlet window to the contact input port.
